(19) United States
(12) Patent Application Publication
(10) Pub. No.: US 2026/0222032 A1
(43) Pub. Date: Jul. 30, 2026

(54) TRANSMISSION CONFIGURATION INDICATOR STATE SELECTION FOR CHANNEL STATE INFORMATION OR PHYSICAL DOWNLINK SHARED CHANNEL

(71) Applicant: QUALCOMM Incorporated, San Diego, CA (US)

(72) Inventors: Fang YUAN, Beijing (CN); Yan ZHOU, San Diego, CA (US)

(21) Appl. No.: 19/146,782

(22) PCT Filed: Mar. 1, 2023
(86) PCT No.: PCT/CN2023/079001

§ 371 Date: Jul. 9, 2025

(51) Int. Cl. H04B 7/06

(52) U.S. Cl. CPC H04B 7/0626; H04B 7/06968

(57) ABSTRACT

Various aspects of the present disclosure generally relate to wireless communication. In some aspects, a user equipment (UE) may receive a configuration for at least one aperiodic channel state information (CSI) reference signal (A-CSI-RS) resource set. The UE may receive an indication of a first unified transmission configuration indicator (TCI) state and a second unified TCI state. The UE may receive downlink control information that triggers an A-CSI state that is associated with the at least one A-CSI-RS resource set. The UE may apply at least one of the first unified TCI state or the second unified TCI state to the at least one A-CSI-RS resource set. The UE may receive one or more A-CSI-RSs using the applied at least one of the first unified TCI state or the second unified TCI state. Numerous other aspects are described.

### FIELD OF THE DISCLOSURE

Aspects of the present disclosure generally relate to wireless communication and to techniques and apparatuses for transmission configuration indicator state selection for channel state information or physical downlink shared channel communications.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a configuration for at least one aperiodic channel state information (CSI) reference signal (A-CSI-RS) resource set. The method may include receiving an indication of a first unified transmission configuration indicator (TCI) state and a second unified TCI state. The method may include receiving downlink control information (DCI) that triggers an aperiodic CSI (A-CSI) state that is associated with the at least one A-CSI-RS resource set. The method may include applying at least one of the first unified TCI state or the second unified TCI state to the at least one A-CSI-RS resource set. The method may include receiving one or more A-CSI-RSs using the applied at least one of the first unified TCI state or the second unified TCI state.

Some aspects described herein relate to a method of wireless communication performed by a network entity. The method may include transmitting a configuration for at least one A-CSI-RS resource set. The method may include transmitting an indication of a first unified TCI state and a second unified TCI state. The method may include transmitting DCI that triggers an A-CSI state that is associated with the at least one A-CSI-RS resource set. The method may include applying at least one of the first unified TCI state or the second unified TCI state to the at least one A-CSI-RS resource set. The method may include transmitting one or more A-CSI-RSs using one or more applied unified TCI states.

Some aspects described herein relate to a method of wireless communication performed by a UE. The method may include receiving a radio resource control (RRC) message that configures the UE for receiving a two-bit TCI state selection field. The method may include receiving DCI that includes a codepoint in the two-bit TCI state selection field. The method may include applying a unified TCI state, which corresponds to the codepoint, to physical downlink shared channel (PDSCH) demodulation reference signal (DMRS) ports for PDSCH occasions scheduled or activated by the DCI. The method may include receiving a PDSCH communication using the unified TCI state.

Some aspects described herein relate to a method of wireless communication performed by a network entity. The method may include transmitting an RRC message that configures a UE for receiving a two-bit TCI state selection field. The method may include transmitting DCI that includes a codepoint in the two-bit TCI state selection field. The method may include applying a unified TCI state, which corresponds to the codepoint, to PDSCH DMRS ports for PDSCH occasions scheduled or activated by the DCI. The method may include transmitting a PDSCH communication using the unified TCI state.

Some aspects described herein relate to a UE for wireless communication. The UE may include a memory and one or more processors coupled to the memory. The one or more processors may be configured to receive a configuration for at least one A-CSI-RS resource set. The one or more processors may be configured to receive an indication of a first unified TCI state and a second unified TCI state. The one or more processors may be configured to receive DCI that triggers an A-CSI state that is associated with the at least one A-CSI-RS resource set. The one or more processors may be configured to apply at least one of the first unified TCI state or the second unified TCI state to the at least one A-CSI-RS resource set. The one or more processors may be configured to receive one or more A-CSI-RSs using the applied at least one of the first unified TCI state or the second unified TCI state.

Some aspects described herein relate to a network entity for wireless communication. The network entity may include a memory and one or more processors coupled to the memory. The one or more processors may be configured to transmit a configuration for at least one A-CSI-RS resource set. The one or more processors may be configured to transmit an indication of a first unified TCI state and a second unified TCI state. The one or more processors may be configured to transmit DCI that triggers an A-CSI state that is associated with the at least one A-CSI-RS resource set. The one or more processors may be configured to apply at least one of the first unified TCI state or the second unified TCI state to the at least one A-CSI-RS resource set. The one or more processors may be configured to transmit one or more A-CSI-RSs using one or more applied unified TCI states.

Some aspects described herein relate to a UE for wireless communication. The UE may include a memory and one or more processors coupled to the memory. The one or more processors may be configured to receive an RRC message that configures the UE for receiving a two-bit TCI state selection field. The one or more processors may be configured to receive DCI that includes a codepoint in the two-bit TCI state selection field. The one or more processors may be configured to apply a unified TCI state, which corresponds to the codepoint, to PDSCH DMRS ports for PDSCH occasions scheduled or activated by the DCI. The one or more processors may be configured to receive a PDSCH communication using the unified TCI state.

Some aspects described herein relate to a network entity for wireless communication. The network entity may include a memory and one or more processors coupled to the memory. The one or more processors may be configured to transmit an RRC message that configures a UE for receiving a two-bit TCI state selection field. The one or more processors may be configured to transmit DCI that includes a codepoint in the two-bit TCI state selection field. The one or more processors may be configured to apply a unified TCI state, which corresponds to the codepoint, to PDSCH DMRS ports for PDSCH occasions scheduled or activated by the DCI. The one or more processors may be configured to transmit a PDSCH communication using the unified TCI state.

Some aspects described herein relate to a non-transitory computer-readable medium that stores a set of instructions for wireless communication by a UE. The set of instructions, when executed by one or more processors of the UE, may cause the UE to receive a configuration for at least one A-CSI-RS resource set. The set of instructions, when executed by one or more processors of the UE, may cause the UE to receive an indication of a first unified TCI state and a second unified TCI state. The set of instructions, when executed by one or more processors of the UE, may cause the UE to receive DCI that triggers an A-CSI state that is associated with the at least one A-CSI-RS resource set. The set of instructions, when executed by one or more processors of the UE, may cause the UE to apply at least one of the first unified TCI state or the second unified TCI state to the at least one A-CSI-RS resource set. The set of instructions, when executed by one or more processors of the UE, may cause the UE to receive one or more A-CSI-RSs using the applied at least one of the first unified TCI state or the second unified TCI state.

Some aspects described herein relate to a non-transitory computer-readable medium that stores a set of instructions for wireless communication by a network entity. The set of instructions, when executed by one or more processors of the network entity, may cause the network entity to transmit a configuration for at least one A-CSI-RS resource set. The set of instructions, when executed by one or more processors of the network entity, may cause the network entity to transmit an indication of a first unified TCI state and a second unified TCI state. The set of instructions, when executed by one or more processors of the network entity, may cause the network entity to transmit DCI that triggers an A-CSI state that is associated with the at least one A-CSI-RS resource set. The set of instructions, when executed by one or more processors of the network entity, may cause the network entity to apply at least one of the first unified TCI state or the second unified TCI state to the at least one A-CSI-RS resource set. The set of instructions, when executed by one or more processors of the network entity, may cause the network entity to transmit one or more A-CSI-RSs using one or more applied unified TCI states.

Some aspects described herein relate to a non-transitory computer-readable medium that stores a set of instructions for wireless communication by a UE. The set of instructions, when executed by one or more processors of the UE, may cause the UE to receive an RRC message that configures the UE for receiving a two-bit TCI state selection field. The set of instructions, when executed by one or more processors of the UE, may cause the UE to receive DCI that includes a codepoint in the two-bit TCI state selection field. The set of instructions, when executed by one or more processors of the UE, may cause the UE to apply a unified TCI state, which corresponds to the codepoint, to PDSCH DMRS ports for PDSCH occasions scheduled or activated by the DCI. The set of instructions, when executed by one or more processors of the UE, may cause the UE to receive a PDSCH communication using the unified TCI state.

Some aspects described herein relate to a non-transitory computer-readable medium that stores a set of instructions for wireless communication by a network entity. The set of instructions, when executed by one or more processors of the network entity, may cause the network entity to transmit an RRC message that configures a UE for receiving a two-bit TCI state selection field. The set of instructions, when executed by one or more processors of the network entity, may cause the network entity to transmit

DCI that includes a codepoint in the two-bit TCI state selection field. The set of instructions, when executed by one or more processors of the network entity, may cause the network entity to apply a unified TCI state, which corresponds to the codepoint, to PDSCH DMRS ports for PDSCH occasions scheduled or activated by the DCI. The set of instructions, when executed by one or more processors of the network entity, may cause the network entity to transmit a PDSCH communication using the unified TCI state.

Some aspects described herein relate to an apparatus for wireless communication. The apparatus may include means for receiving a configuration for at least one A-CSI-RS resource set. The apparatus may include means for receiving an indication of a first unified TCI state and a second unified TCI state. The apparatus may include means for receiving DCI that triggers an A-CSI state that is associated with the at least one A-CSI-RS resource set. The apparatus may include means for applying at least one of the first unified TCI state or the second unified TCI state to the at least one A-CSI-RS resource set. The apparatus may include means for receiving one or more A-CSI-RSs using the applied at least one of the first unified TCI state or the second unified TCI state.

Some aspects described herein relate to an apparatus for wireless communication. The apparatus may include means for transmitting a configuration for at least one A-CSI-RS resource set. The apparatus may include means for transmitting an indication of a first unified TCI state and a second unified TCI state. The apparatus may include means for transmitting DCI that triggers an A-CSI state that is associated with the at least one A-CSI-RS resource set. The apparatus may include means for applying at least one of the first unified TCI state or the second unified TCI state to the at least one A-CSI-RS resource set. The apparatus may include means for transmitting one or more A-CSI-RSs using one or more applied unified TCI states.

Some aspects described herein relate to an apparatus for wireless communication. The apparatus may include means for receiving an RRC message that configures the apparatus for receiving a two-bit TCI state selection field. The apparatus may include means for receiving DCI that includes a codepoint in the two-bit TCI state selection field. The apparatus may include means for applying a unified TCI state, which corresponds to the codepoint, to PDSCH DMRS ports for PDSCH occasions scheduled or activated by the DCI. The apparatus may include means for receiving a PDSCH communication using the unified TCI state.

Some aspects described herein relate to an apparatus for wireless communication. The apparatus may include means for transmitting an RRC message that configures a UE for receiving a two-bit TCI state selection field. The apparatus may include means for transmitting DCI that includes a codepoint in the two-bit TCI state selection field. The apparatus may include means for applying a unified TCI state, which corresponds to the codepoint, to PDSCH DMRS ports for PDSCH occasions scheduled or activated by the DCI. The apparatus may include means for transmitting a PDSCH communication using the unified TCI state.

Aspects generally include a method, apparatus, system, computer program product, non-transitory computer-readable medium, UE, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network entity (e.g., base station) in communication with a user equipment (UE) in a wireless network, in accordance with the present disclosure.

FIG. 3 is a diagram illustrating an example of a disaggregated base station, in accordance with the present disclosure.

FIG. 4 illustrates an example logical architecture of a distributed random access network, in accordance with the present disclosure.

FIG. 5 is a diagram illustrating an example of multiple transmit receive point (TRP) communication, in accordance with the present disclosure.

FIG. 6 is a diagram illustrating an example of multiple TRP operation, in accordance with the present disclosure.

FIG. 7 is a diagram illustrating an example of coherent joint transmission (CJT) and non-CJT for multiple TRPs, in accordance with the present disclosure.

FIG. 8 is a diagram illustrating examples of beam management procedures, in accordance with the present disclosure.

FIG. 9 is a diagram illustrating an example of using beams for communications between a network entity and a UE, in accordance with the present disclosure.

FIG. 10 is a diagram illustrating an example of transmission configuration indicator (TCI) state selection for aperiodic channel station information reference signal resource sets, in accordance with the present disclosure.

FIG. 11 is a diagram illustrating an example of TCI state selection for a physical downlink shared channel, in accordance with the present disclosure.

FIG. 12 is a diagram illustrating an example process performed, for example, by a UE, in accordance with the present disclosure.

FIG. 13 is a diagram illustrating an example process performed, for example, by a network entity, in accordance with the present disclosure.

FIG. 14 is a diagram illustrating an example process performed, for example, by a UE, in accordance with the present disclosure.

FIG. 15 is a diagram illustrating an example process performed, for example, by a network entity, in accordance with the present disclosure.

FIG. 16 is a diagram of an example apparatus for wireless communication, in accordance with the present disclosure.

FIG. 17 is a diagram of an example apparatus for wireless communication, in accordance with the present disclosure.

### DETAILED DESCRIPTION

A downlink beam may be associated with a transmission configuration indication (TCI) state. A TCI state may indicate a directionality or a characteristic of the downlink beam, such as one or more quasi-co-location (QCL) properties of the downlink beam. A QCL property may include, for example, a Doppler shift, a Doppler spread, an average delay, a delay spread, or spatial receive parameters, among other examples. A TCI state may be associated with an aperiodic channel state information reference signal (A-CSI-RS), which is triggered by DCI and used for channel estimation. A TCI state may also be associated with a downlink transmission on a physical downlink shared channel (PDSCH). In a unified TCI state framework, a TCI state may be used to indicate more than one beam. The TCI state may be used to indicate beams for a downlink channel or reference signal (RS) and/or an uplink channel or RS. There may be multiple types of unified TCI states. For example, a joint downlink/uplink common TCI state may indicate a common beam for at least one downlink channel or RS and at least one uplink channel or RS.

In some scenarios, a user equipment (UE) may receive a configuration for CSI reporting information for an A-CSI trigger state, which involves A-CSI-RSs that are received using A-CSI-RS resource sets. In a unified TCI framework for a DCI for multiple transmit receive points (TRPs), QCL information (e.g., QCL-Info) may be absent from the CSI reporting information. Without such QCL information, it is not clear to the UE what unified TCI states the UE is to apply for one or more A-CSI-RS resource sets. This uncertainty can lead to suboptimal unified TCI state selection for A-CSI-RSs, which will reduce the accuracy of A-CSI and degrade communications. Degraded communications wastes processing resources and signaling resources.

According to various aspects described herein, the UE may receive an indication of unified TCI states to apply to A-CSI-RS resource sets. In this way, the UE has clarity when providing A-CSI feedback in response to receiving a DCI. The A-CSI and associated communications will improve. As a result, the UE conserves processing resources and signaling resources. In some aspects, the configuration may indicate which TCI states apply to which A-CSI-RS resource set. In some aspects, the DCI may indicate this information. In some aspects, the DCI may include a codepoint in a TCI state selection field that is used to indicate how to apply TCI states for PDSCH communications.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

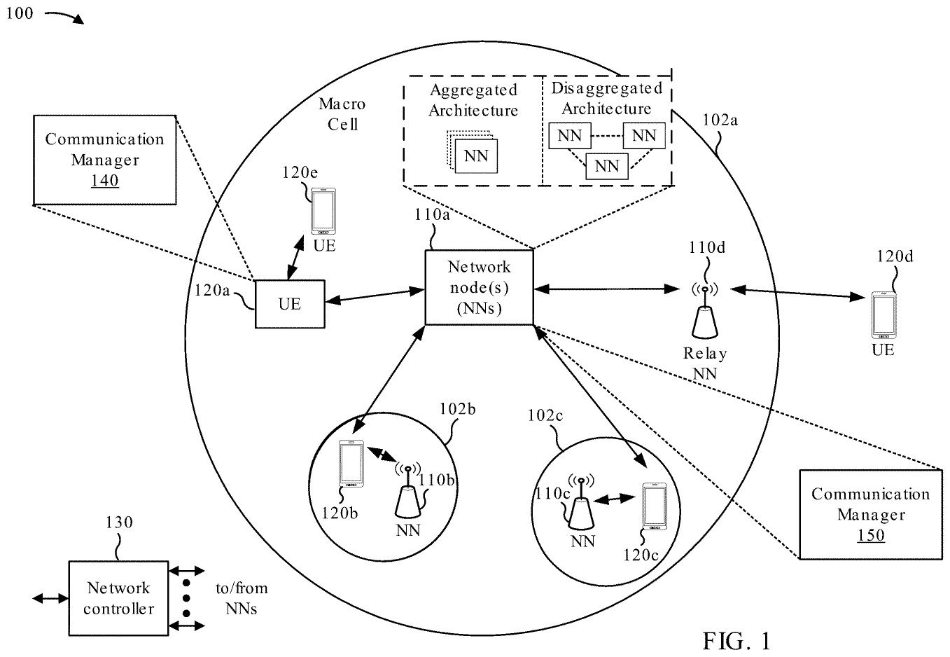

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the

UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHZ-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHZ” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., a UE 120) may include a communication manager 140. As described in more detail elsewhere herein, the communication manager 140 may receive a configuration for at least one A-CSI-RS resource set. The communication manager 140 may receive an indication of a first unified TCI state and a second unified TCI state. The communication manager 140 may receive DCI that triggers an A-CSI state that is associated with the at least one A-CSI-RS resource set. The communication manager 140 may apply at least one of the first unified TCI state or the second unified TCI state to the at least one A-CSI-RS resource set. The communication manager 140 may receive one or more A-CSI-RSs using the applied at least one of the first unified TCI state or the second unified TCI state.

In some aspects, the communication manager 140 may receive a radio resource control (RRC) message that configures the UE for receiving a two-bit TCI state selection field. The communication manager 140 may receive DCI that includes a codepoint in the two-bit TCI state selection field. The communication manager 140 may apply a unified TCI state, which corresponds to the codepoint, to PDSCH demodulation reference signal (DMRS) ports for PDSCH occasions scheduled or activated by the DCI. The communication manager 140 may receive a PDSCH communication using the unified TCI state. Additionally, or alternatively, the communication manager 140 may perform one or more other operations described herein.

In some aspects, a network entity (e.g., a network node 110) may include a communication manager 150. As described in more detail elsewhere herein, the communication manager 150 may transmit a configuration for at least one A-CSI-RS resource set. The communication manager 150 may transmit an indication of a first unified TCI state and a second unified TCI state. The communication manager 150 may transmit DCI that triggers an A-CSI state that is associated with the at least one A-CSI-RS resource set. The communication manager 150 may apply at least one of the first unified TCI state or the second unified TCI state to the at least one A-CSI-RS resource set. The communication manager 150 may transmit one or more A-CSI-RSs using one or more applied unified TCI states.

In some aspects, the communication manager 150 may transmit an RRC message that configures a UE for receiving a two-bit TCI state selection field. The communication manager 150 may transmit DCI that includes a codepoint in the two-bit TCI state selection field. The communication manager 150 may apply a unified TCI state, which corresponds to the codepoint, to PDSCH DMRS ports for PDSCH occasions scheduled or activated by the DCI. The communication manager 150 may transmit a PDSCH communication using the unified TCI state. Additionally, or alternatively, the communication manager 150 may perform one or more other operations described herein.

As indicated above, FIG. 1 is provided as an example. Other examples may differ from what is described with regard to FIG. 1.

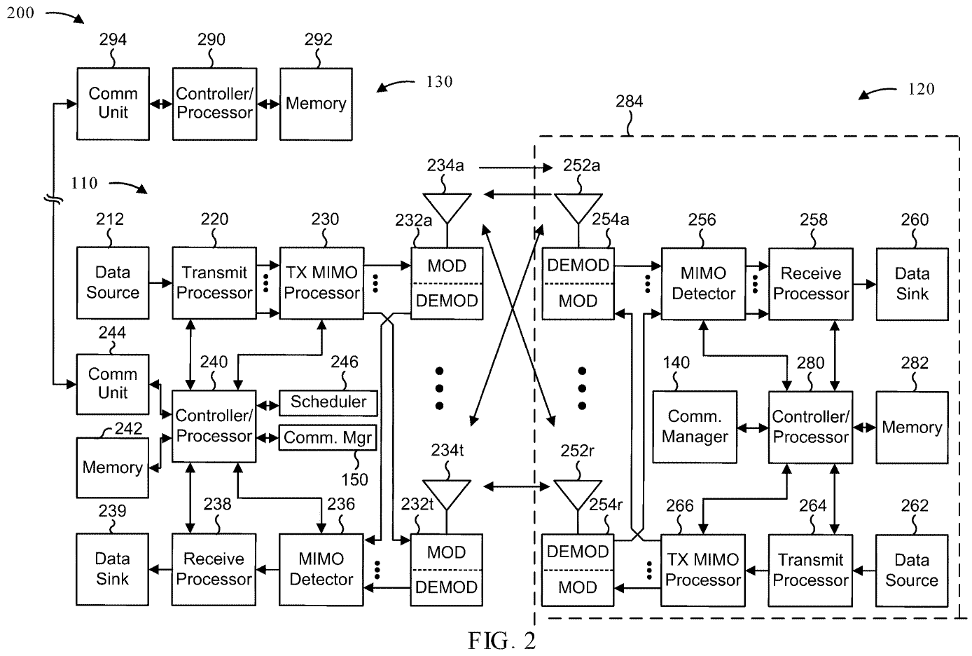

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

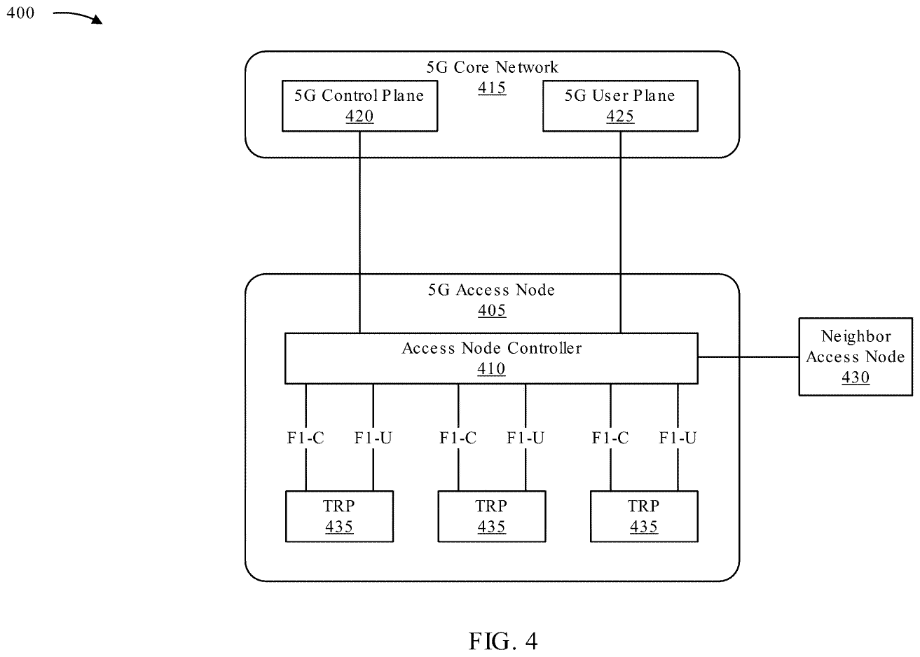

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-17).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-17).

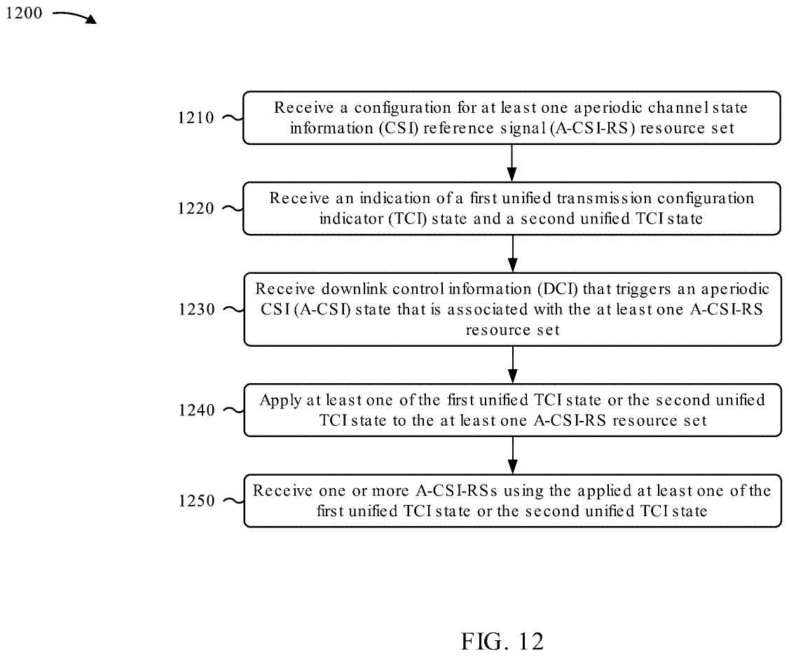

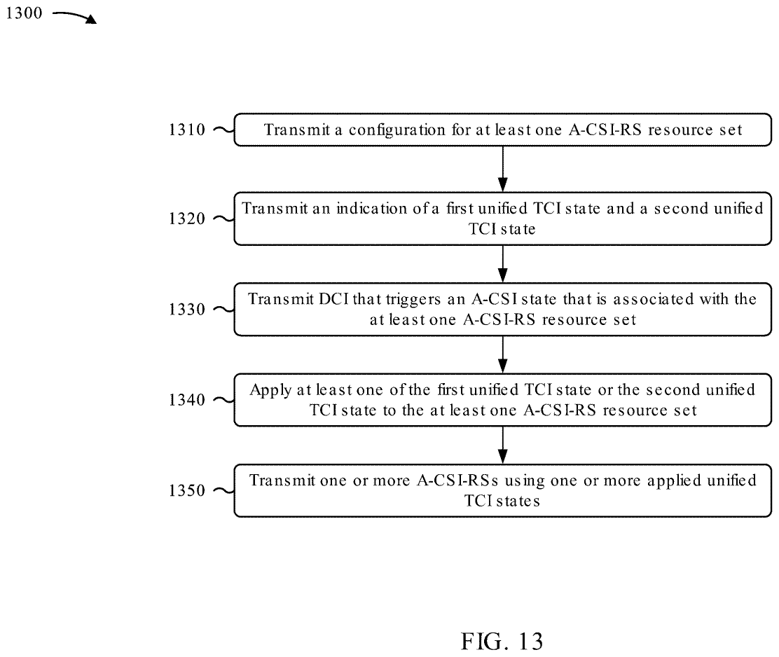

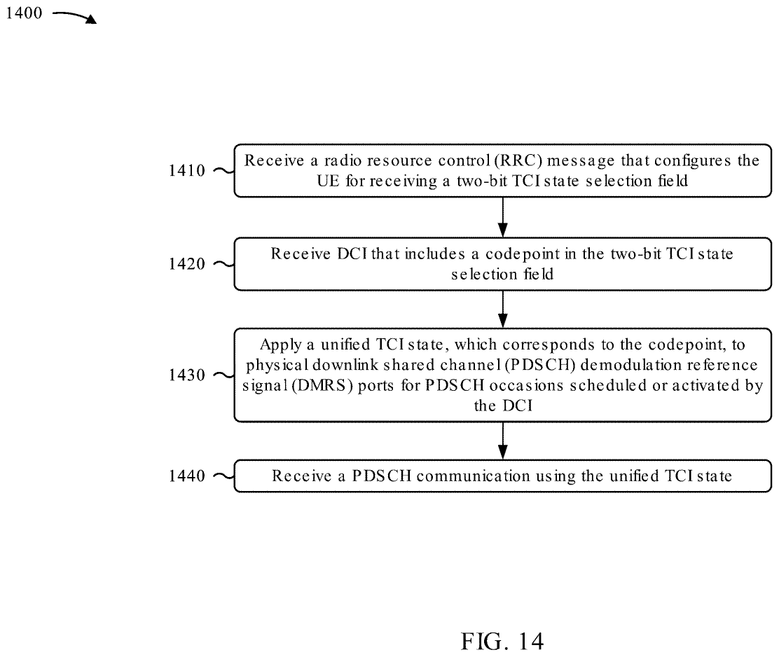

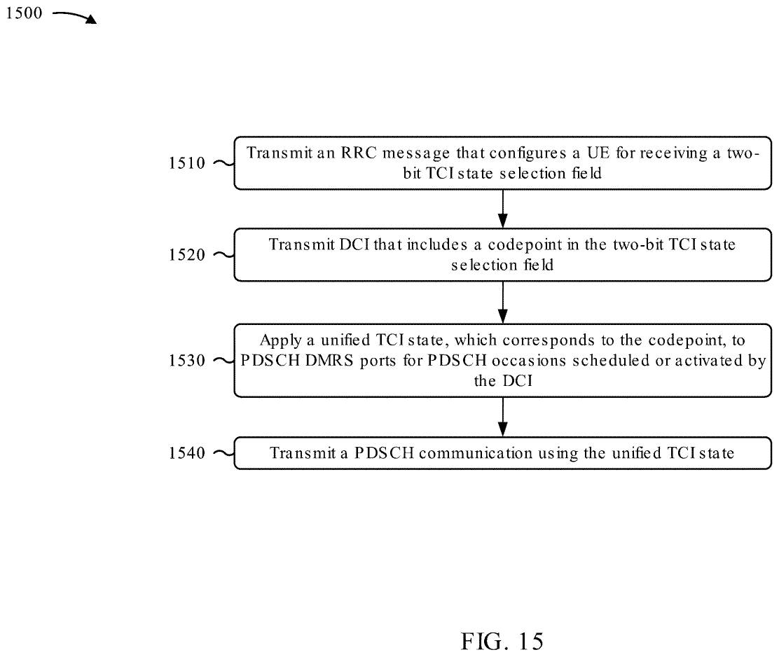

A controller/processor of a network entity (e.g., the controller/processor 240 of the network node 110), the controller/processor 280 of the UE 120, and/or any other component(s) of FIG. 2 may perform one or more techniques associated with TCI state selection for A-CSI and PDSCH, as described in more detail elsewhere herein. For example, the controller/processor 240 of the network node 110, the controller/processor 280 of the UE 120, and/or any other component(s) of FIG. 2 may perform or direct operations of, for example, process 1200 of FIG. 12, process 1300 of FIG. 13, process 1400 of FIG. 14, process 1500 of FIG. 15, and/or other processes as described herein. The memory 242 and the memory 282 may store data and program codes for the network entity and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network entity and/or the UE 120, may cause the one or more processors, the UE 120, and/or the network entity to perform or direct operations of, for example, process 1200 of FIG. 12, process 1300 of FIG. 13, process 1400 of FIG. 14, process 1500 of FIG. 15, and/or other processes as described herein. In some examples, executing instructions may include running the instructions, converting the instructions, compiling the instructions, and/or interpreting the instructions, among other examples.

In some aspects, a UE (e.g., a UE 120) includes means for receiving a configuration for at least one A-CSI-RS resource set; means for receiving an indication of a first unified transmission configuration indicator (TCI) state and a second unified TCI state; means for receiving downlink control information (DCI) that triggers an A-CSI state that is associated with the at least one A-CSI-RS resource set; means for applying at least one of the first unified TCI state or the second unified TCI state to the at least one A-CSI-RS resource set; and/or means for receiving one or more A-CSI-RSs using the applied at least one of the first unified TCI state or the second unified TCI state. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE includes means for receiving an RRC message that configures the UE for receiving a two-bit TCI state selection field; means for receiving DCI that includes a codepoint in the two-bit TCI state selection field; means for applying a unified TCI state, which corresponds to the codepoint, to PDSCH DMRS ports for PDSCH occasions scheduled or activated by the DCI; and/or means for receiving a PDSCH communication using the unified TCI state.

In some aspects, a network entity (e.g., a network node 110) includes means for transmitting a configuration for at least one A-CSI-RS resource set; means for transmitting an indication of a first unified TCI state and a second unified TCI state; means for transmitting DCI that triggers an A-CSI state that is associated with the at least one A-CSI-RS resource set; means for applying at least one of the first unified TCI state or the second unified TCI state to the at least one A-CSI-RS resource set; and/or means for transmitting one or more A-CSI-RSs using one or more applied unified TCI states.

In some aspects, the network entity includes means for transmitting an RRC message that configures a UE for receiving a two-bit TCI state selection field; means for transmitting DCI that includes a codepoint in the two-bit TCI state selection field; means for applying a unified TCI state, which corresponds to the codepoint, to PDSCH DMRS ports for PDSCH occasions scheduled or activated by the DCI; and/or means for transmitting a PDSCH communication using the unified TCI state.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

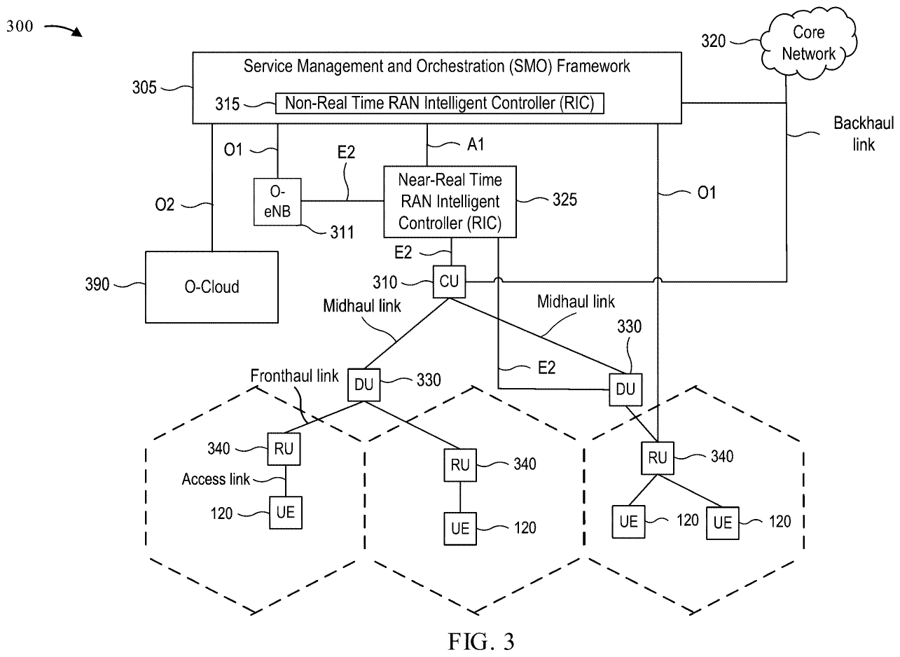

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 illustrates an example logical architecture of a distributed RAN 400, in accordance with the present disclosure.

A 5G access node 405 may include an access node controller 410. The access node controller 410 may be a CU of the distributed RAN 400. In some aspects, a backhaul interface to a 5G core network 415 may terminate at the access node controller 410. The 5G core network 415 may include a 5G control plane component 420 and a 5G user plane component 425 (e.g., a 5G gateway), and the backhaul interface for one or both of the 5G control plane and the 5G user plane may terminate at the access node controller 410. Additionally, or alternatively, a backhaul interface to one or more neighbor access nodes 430 (e.g., another 5G access node 405 and/or an LTE access node) may terminate at the access node controller 410.

The access node controller 410 may include and/or may communicate with one or more TRPs 435 (e.g., via an F1 Control (F1-C) interface and/or an F1 User (F1-U) interface). A TRP 435 may be a DU of the distributed RAN 400. In some aspects, a TRP 435 may correspond to a network node 110 described above in connection with FIG. 1. For example, different TRPs 435 may be included in different base stations 110. Additionally, or alternatively, multiple TRPs 435 may be included in a single network node 110. In some aspects, a network node 110 may include a CU (e.g., access node controller 410) and/or one or more DUs (e.g., one or more TRPs 435). In some cases, a TRP 435 may be referred to as a cell, a panel, an antenna array, or an array.

A TRP 435 may be connected to a single access node controller 410 or to multiple access node controllers 410. In some aspects, a dynamic configuration of split logical functions may be present within the architecture of distributed RAN 400. For example, a PDCP layer, an RLC layer, and/or a MAC layer may be configured to terminate at the access node controller 410 or at a TRP 435.

In some aspects, multiple TRPs 435 may transmit communications (e.g., the same communication or different communications) in the same transmission time interval (TTI) (e.g., a slot, a mini-slot, a subframe, or a symbol) or different TTIs using different QCL relationships (e.g., different spatial parameters, different TCI states, different precoding parameters, and/or different beamforming parameters). In some aspects, a TCI state may be used to indicate one or more QCL relationships. A TRP 435 may be configured to individually (e.g., using dynamic selection) or jointly (e.g., using joint transmission with one or more other TRPs 435) serve traffic to a UE 120.

As indicated above, FIG. 4 is provided as an example. Other examples may differ from what was described with regard to FIG. 4.

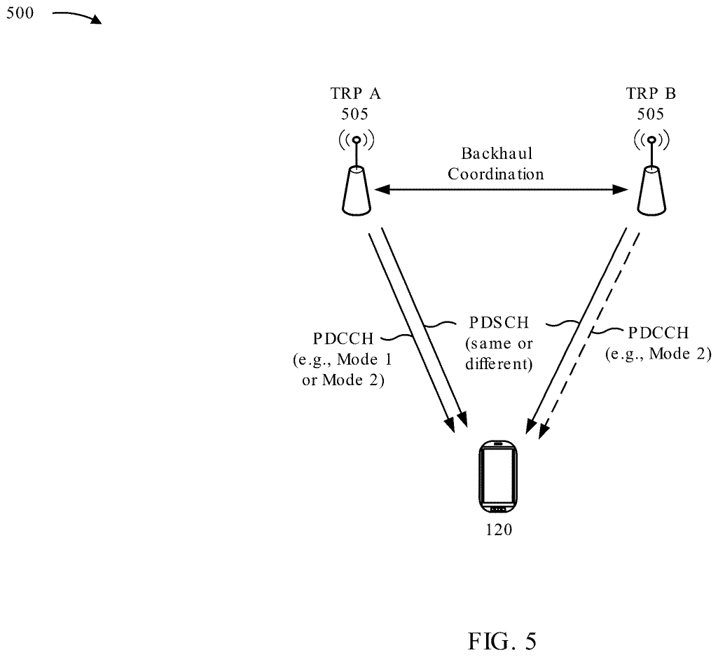

FIG. 5 is a diagram illustrating an example 500 of multiple TRP (multi-TRP) communication (sometimes referred to as multi-panel communication), in accordance with the present disclosure. As shown in FIG. 5, multiple TRPs 505 may communicate with the same UE 120. A TRP 505 may correspond to a TRP 435 described above in connection with FIG. 4.

The multiple TRPs 505 (shown as TRP A and TRP B) may communicate with the same UE 120 in a coordinated manner (e.g., using coordinated multipoint transmissions) to improve reliability and/or increase throughput. The TRPs 505 may coordinate such communications via an interface between the TRPs 505 (e.g., a backhaul interface and/or an access node controller 410). The interface may have a smaller delay and/or higher capacity when the TRPs 505 are co-located at the same network node 110 (e.g., when the TRPs 505 are different antenna arrays or panels of the same network node 110), and may have a larger delay and/or lower capacity (as compared to co-location) when the TRPs 505 are located at different base stations 110. The different TRPs 505 may communicate with the UE 120 using different QCL relationships (e.g., different TCI states), different DMRS ports, and/or different layers (e.g., of a multi-layer communication).

In a first multi-TRP transmission mode (e.g., Mode 1), a single physical downlink control channel (PDCCH) may be used to schedule downlink data communications for a single PDSCH. In this case, multiple TRPs 505 (e.g., TRP A and TRP B) may transmit communications to the UE 120 on the same PDSCH. For example, a communication may be transmitted using a single codeword with different spatial layers for different TRPs 505 (e.g., where one codeword maps to a first set of layers transmitted by a first TRP 505 and maps to a second set of layers transmitted by a second TRP 505). As another example, a communication may be transmitted using multiple codewords, where different codewords are transmitted by different TRPs 505 (e.g., using different sets of layers). In either case, different TRPs 505 may use different QCL relationships (e.g., different TCI states) for different DMRS ports corresponding to different layers. For example, a first TRP 505 may use a first QCL relationship or a first TCI state for a first set of DMRS ports corresponding to a first set of layers, and a second TRP 505 may use a second (different) QCL relationship or a second (different) TCI state for a second (different) set of DMRS ports corresponding to a second (different) set of layers. In some aspects, a TCI state in DCI (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by a first TRP 505, and a second PDCCH may schedule a second codeword to be transmitted by a second TRP 505. Furthermore, first DCI (e.g., transmitted by the first TRP 505) may schedule a first PDSCH communication associated with a first set of DMRS ports with a first QCL relationship (e.g., indicated by a first TCI state) for the first TRP 505, and second DCI (e.g., transmitted by the second TRP 505) may schedule a second PDSCH communication associated with a second set of DMRS ports with a second QCL relationship (e.g., indicated by a second TCI state) for the second TRP 505. In this case, DCI (e.g., having DCI format 1_0 or DCI format 1_1) may indicate a corresponding TCI state for a TRP 505 corresponding to the DCI. The TCI field of a DCI indicates the corresponding TCI state (e.g., the TCI field of the first DCI indicates the first TCI state and the TCI field of the second DCI indicates the second TCI state).

As indicated above, FIG. 5 is provided as an example. Other examples may differ from what is described with respect to FIG. 5.

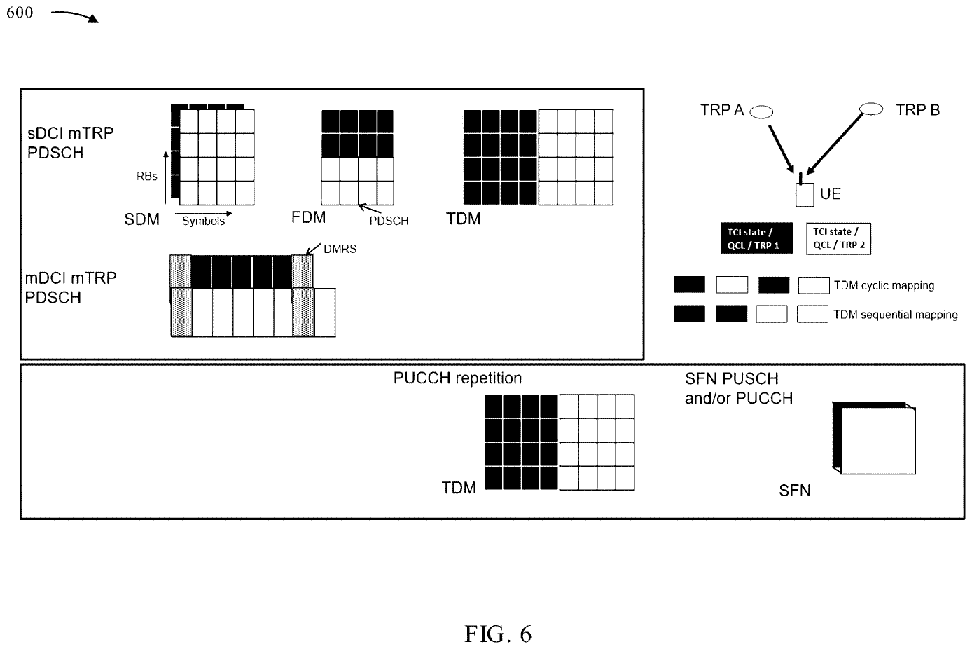

FIG. 6 is a diagram illustrating an example 600 of multi-TRP operation, in accordance with the present disclosure.

Example 600 shows that a single DCI (sDCI) for multi-TRP PDSCH may include spatial division multiplexing (SDM), frequency division multiplexing (FDM), or time division multiplexing (TDM). Example 600 shows that with multi-TRPs, the TRPs may use TDM cyclic mapping or TDM sequential mapping. Example 600 also shows that a multiple DCI (mDCI) for multi-TRP PDSCH may include DMRSs for SDM.

Example 600 shows that TDM can be used for physical uplink control channel (PUCCH) repetition. Example 600 also shows that a single frequency network (SFN) may use SDM for physical uplink shared channel (PUSCH) and/or PUCCH.

As indicated above, FIG. 6 is provided as an example. Other examples may differ from what is described with regard to FIG. 6.

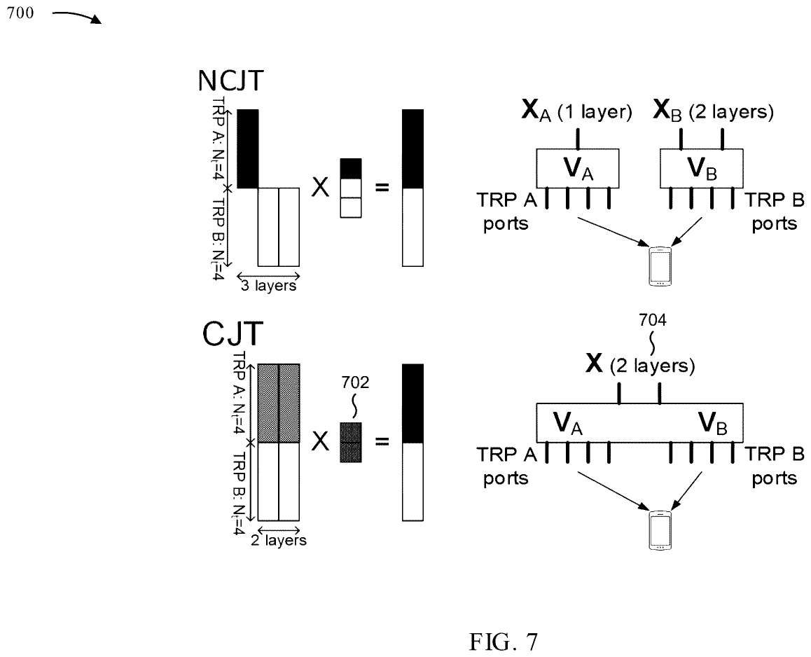

FIG. 7 is a diagram illustrating an example 700 of CJT and non-CJT (NCJT) for multiple TRPs, in accordance with the present disclosure.

CJT involves multiple transmitters that each transmit a message with a phase that is constructively combined at a receiver. CJT may include beamforming with antennas that are not co-located and that correspond to different TRPs. CJT may improve the signal power and spatial diversity of communications in an NR network.

For NCJT that is based on SDM, data is precoded separately on different TRPs. For example, precoder A is precoded for one TRP, and precoder B is precoded for a separate TRP. This may be expressed as:

$$[ \begin{matrix}{V}_{A} & 0 \\ 0 & {V}_{B}\end{matrix} ] [ \begin{matrix}{X}_{A} \\ {X}_{B}\end{matrix} ] = [ \begin{matrix}{V}_{A} {X}_{A} \\ {V}_{B} {X}_{B}\end{matrix} ] ,$$

where letters not in bold are for precoder A and data for a first TRP, and letters in bold are for precoder B and data for a second TRP. For example, precoder

$$( {N}_{t}^{T R P} \times {RI}^{T R P} ) {V}_{A} : 4 \times 1 , {V}_{B} : 4 \times 2$$

may indicate a precoder for a specific TRP and rank (indicated by rank indicator (RI)). Data (RI^{TRP}×1) X_{A}:1×1, X_{B}:2×1 may indicate data by TRP and RI.

For CJT, data is precoded jointly on different TRPs. This may be expressed, and for example, as:

$$[ \begin{matrix}{V}_{A} \\ {V}_{B}\end{matrix} ] \cdot X = [ \begin{matrix}{V}_{A} X \\ {V}_{B} X\end{matrix} ] ,$$

precoder

$$( {N}_{t}^{T R P} \times {RI}^{CJT} ) {V}_{A} : 4 \times 2 , {V}_{B} : 4 \times 2 ,$$

and data (RI^{CJT}×1) X:2×1. Reference number 702 shows joint precoding for multiple TRPs rather than separate precoding as shown for NCJT. Reference number 704 shows two layers that are jointly precoded.

As indicated above, FIG. 7 is provided as an example. Other examples may differ from what is described with regard to FIG. 7.

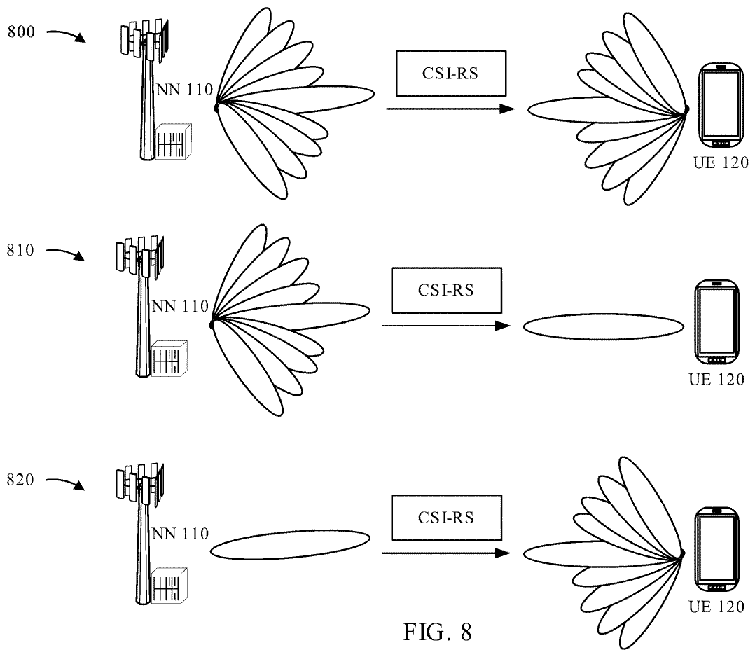

FIG. 8 is a diagram illustrating examples 800, 810, and 820 of beam management procedures, in accordance with the present disclosure. As shown in FIG. 8, examples 800, 810, and 820 include a UE 120 in communication with a network entity (e.g., network node 110) in a wireless network (e.g., wireless network 100). However, the devices shown in FIG. 8 are provided as examples, and the wireless network may support communication and beam management between other devices (e.g., between a UE 120 and a network node 110 or TRP, between a mobile termination node and a control node, between an IAB child node and an IAB parent node, and/or between a scheduled node and a scheduling node). In some aspects, the UE 120 and the network node 110 may be in a connected state (e.g., an RRC connected state).

As shown in FIG. 8, example 800 may include a network node (NN) 110 and a UE 120 communicating to perform beam management using CSI-RSs. Example 800 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 8 and example 800, CSI-RSs may be configured to be transmitted from the network node 110 to the UE 120. The CSI-RSs may be configured to be periodic (e.g., using RRC signaling), semi-persistent (e.g., using MAC control element (MAC CE) signaling), and/or aperiodic (e.g., using DCI).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the base station may use a transmit beam to transmit (e.g., with repetitions) each CSI-RS at multiple times within the same RS resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 800 has been described in connection with CSI-RSs, the first beam management process may also use synchronization signal blocks (SSBs) for beam management in a similar manner as described above.

As shown in FIG. 8, example 810 may include a network node 110 and a UE 120 communicating to perform beam management using CSI-RSs. Example 810 depicts a second beam management procedure (e.g., P2 CSI-RS beam management). The second beam management procedure may be referred to as a beam refinement procedure, a base station beam refinement procedure, a TRP beam refinement procedure, and/or a transmit beam refinement procedure. As shown in FIG. 8 and example 810, CSI-RSs may be configured to be transmitted from the network node 110 to the UE 120. The CSI-RSs may be configured to be aperiodic (e.g., using DCI), or A-CSI. The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 8, example 820 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 8 and example 820, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the base station may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

As indicated above, FIG. 8 is provided as an example of beam management procedures. Other examples of beam management procedures may differ from what is described with respect to FIG. 8. For example, the UE 120 and the network node 110 may perform the third beam management procedure before performing the second beam management procedure, and/or the UE 120 and the network node 110 may perform a similar beam management procedure to select a UE transmit beam.

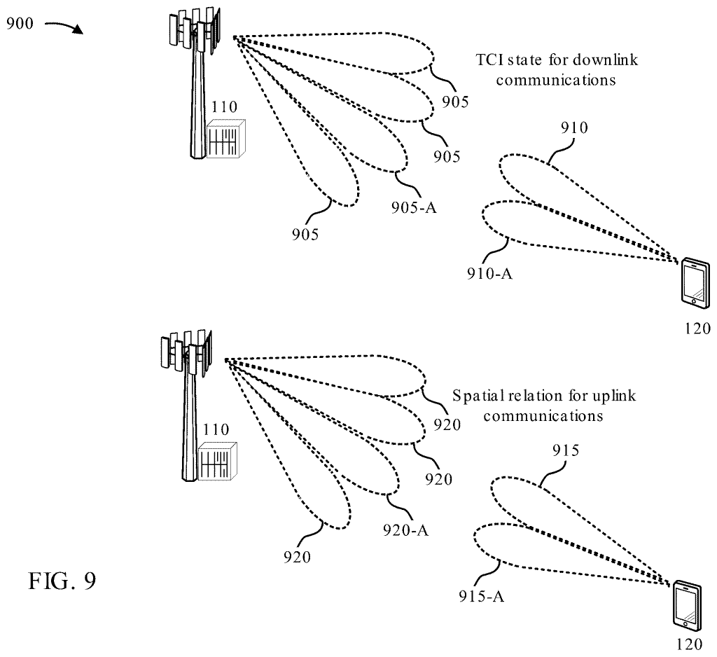

FIG. 9 is a diagram illustrating an example 900 of using beams for communications between a network entity (e.g., network node 110) and a UE (e.g., UE 120), in accordance with the present disclosure. As shown in FIG. 9, a network node 110 and a UE 120 may communicate with one another.

The network node 110 may transmit to UEs 120 located within a coverage area of the network node 110. The network node 110 and the UE 120 may be configured for beamformed communications, where the network node 110 may transmit in the direction of the UE 120 using a directional network entity transmit beam (e.g., a BS transmit beam), and the UE 120 may receive the transmission using a directional UE receive beam. Each transmit beam may have an associated beam identifier (ID), beam direction, or beam symbols, among other examples. The network node 110 may transmit downlink communications via one or more transmit beams 905.

The UE 120 may attempt to receive downlink transmissions via one or more UE receive beams 910, which may be configured using different beamforming parameters at receive circuitry of the UE 120. The UE 120 may identify a particular transmit beam 905, shown as transmit beam 905-A, and a particular UE receive beam 910, shown as UE receive beam 910-A, that provide relatively favorable performance (for example, that have a best channel quality of the different measured combinations of transmit beams 905 and UE receive beams 910). In some examples, the UE 120 may transmit an indication of which transmit beam 905 is identified by the UE 120 as a preferred transmit beam, which the network node 110 may select for transmissions to the UE 120. The UE 120 may thus attain and maintain a beam pair link (BPL) with the network node 110 for downlink communications (for example, a combination of the transmit beam 905-A and the UE receive beam 910-A), which may be further refined and maintained in accordance with one or more established beam refinement procedures.

A downlink beam, such as a transmit beam 905 or a UE receive beam 910, may be associated with a TCI state. A TCI state may indicate a directionality or a characteristic of the downlink beam, such as one or more QCL properties of the downlink beam. A QCL property may include, for example, a Doppler shift, a Doppler spread, an average delay, a delay spread, or spatial receive parameters, among other examples. In some examples, each transmit beam 905 may be associated with a synchronization signal block (SSB), and the UE 120 may indicate a preferred transmit beam 905 by transmitting uplink transmissions in resources of the SSB that are associated with the preferred transmit beam 905. A particular SSB may have an associated TCI state (for example, for an antenna port or for beamforming). The network node 110 may, in some examples, indicate a downlink transmit beam 905 based at least in part on antenna port QCL properties that may be indicated by the TCI state. A TCI state may be associated with one downlink reference signal set (for example, an SSB and an aperiodic, periodic, or semi-persistent CSI-RS) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 910 at the UE 120. Thus, the UE 120 may select a corresponding UE receive beam 910 from a set of BPLs based at least in part on the network node 110 indicating a transmit beam 905 via a TCI indication.

The network node 110 may maintain a set of activated TCI states for downlink shared channel transmissions and a set of activated TCI states for downlink control channel transmissions. The set of activated TCI states for downlink shared channel transmissions may correspond to beams that the network node 110 uses for downlink transmission on a PDSCH. The set of activated TCI states for downlink control channel communications may correspond to beams that the network node 110 may use for downlink transmission on a PDCCH or in a CORESET. The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as an RRC message.

Similarly, for uplink communications, the UE 120 may transmit in the direction of the network node 110 using a directional UE transmit beam, and the network node 110 may receive the transmission using a directional receive beam. Each UE transmit beam may have an associated beam ID, beam direction, or beam symbols, among other examples. The UE 120 may transmit uplink communications via one or more UE transmit beams 915.

The network node 110 may receive uplink transmissions via one or more receive beams 920 (e.g., BS receive beams). The network node 110 may identify a particular UE transmit beam 915, shown as UE transmit beam 915-A, and a particular receive beam 920, shown as receive beam 920-A, that provide relatively favorable performance (for example, that have a best channel quality of the different measured combinations of UE transmit beams 915 and receive beams 920). In some examples, the network node 110 may transmit an indication of which UE transmit beam 915 is identified by the network node 110 as a preferred UE transmit beam, which the network node 110 may select for transmissions from the UE 120. The UE 120 and the network node 110 may thus attain and maintain a BPL for uplink communications (for example, a combination of the UE transmit beam 915-A and the receive beam 920-A), which may be further refined and maintained in accordance with one or more established beam refinement procedures. An uplink beam, such as a UE transmit beam 915 or a receive beam 920, may be associated with a spatial relation. A spatial relation may indicate a directionality or a characteristic of the uplink beam, similar to one or more QCL properties, as described above.

3GPP standards Release 17 established a unified TCI state framework in which a TCI state may be used to indicate more than one beam. The TCI state may be used to indicate beams for a downlink channel or reference signal (RS) and/or an uplink channel or RS. There may be multiple types of unified TCI states. For example, a joint TCI state may indicate a common beam for at least one downlink channel or RS and at least one uplink channel or RS. This may be Type 1 and may include at least a UE-specific PDCCH, PDSCH, PUCCH, and PUSCH. A downlink TCI state may indicate a common beam for more than one downlink channel or RS. This may be Type 2 and may include at least a UE-specific PDCCH and PDSCH. An uplink TCI state may indicate a common beam for more than one uplink channel or RS. This may be Type 3 and may include at least a UE-specific PUCCH and PUSCH. Other types of unified TCI states may include a separate downlink single channel or RS TCI state that indicates a beam for a single downlink channel or RS, a separate uplink single channel or RS TCI state that indicates a beam for a single uplink channel or RS, or an uplink spatial relation information, such as a spatial relation indicator (SRI), that indicates a beam for a single uplink channel or RS.

A network entity may transmit a unified TCI state indication that indicates a unified TCI state. The unified TCI state indication may provide, for a downlink or a joint TCI state, QCL-Type1 (e.g., for QCL-Type A) and QCL-Type2 (e.g., for QCL-Type D). The unified TCI state indication may also provide, for a downlink or a joint TCI state, power control parameters, such as a P0 value, an alpha value, or cross-link interference (CLI) information. For a joint TCI state, the unified TCI state indication may indicate a path loss RS. For an uplink TCI state, the unified TCI state indication may indicate an RS (e.g., for a spatial filter) and/or power control parameters.

A UE may be configured for A-CSI, and A-CSI may be triggered by DCI. The configuration for an A-CSI trigger state may be included in reporting configuration information, such as CSI-AssociatedReportConfigInfo of CSI-AperiodicTriggerState. A-CSI may involve A-CSI-RSs that are received using A-CSI-RS resource sets. In a unified TCI framework for sDCI for multi-TRP, QCL information (e.g., QCL-Info) may be absent for an A-CSI resource set that is configured for CSI feedback and beam management. Without such QCL information, it is not clear to the UE what unified TCI states the UE is to use for one or more A-CSI-RS resource sets. This uncertainty can lead to suboptimal unified TCI state selection for A-CSI-RSs, which will reduce the accuracy of A-CSI and degrade communications. Degraded communications wastes processing resources and signaling resources.

As indicated above, FIG. 9 is provided as an example. Other examples may differ from what is described with respect to FIG. 9.

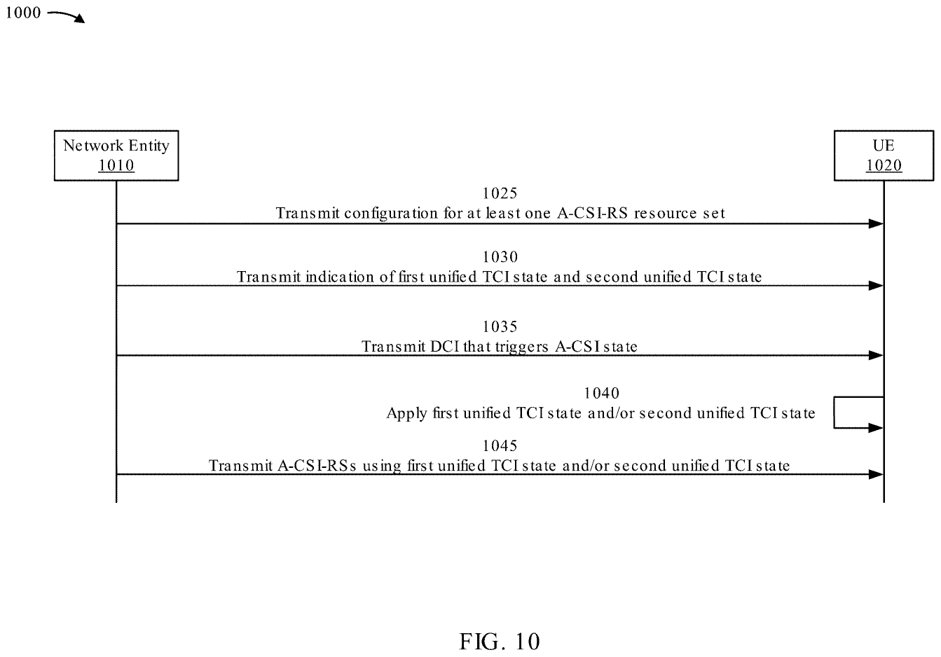

FIG. 10 is a diagram illustrating an example 1000 of TCI state selection for A-CSI-RS resource sets, in accordance with the present disclosure.

According to various aspects described herein, the UE may receive an indication of unified TCI states to apply to A-CSI-RS resource sets. In this way, the UE has clarity when providing A-CSI feedback in response to receiving a DCI. The A-CSI and associated communications will improve. As a result, the UE conserves processing resources and signaling resources.

In some aspects, the DCI may include an sDCI. QCL information may be absent from the CSI reporting configuration associated with triggering the A-CSI state. In some aspects, a network entity may transmit an indication of how to apply the unified TCI states in an RRC configuration. The configuration may include CSI reporting configuration information associated with triggering the A-CSI state (e.g., CSI-AssociatedReportConfigInfo of CSI-AperiodicTriggerState). The configuration may indicate that the UE is to apply the first unified TCI state to the A-CSI-RS resource set or apply the second unified TCI state to the A-CSI-RS resource set.

In some aspects, the network entity may transmit an indication of how to apply the unified TCI states in the DCI. The configuration for using the DCI to indicate unified TCI states may be included in CSI reporting configuration information associated with triggering the A-CSI state (e.g., CSI-AssociatedReportConfigInfo of CSI-AperiodicTriggerState). The DCI may indicate that the UE is to apply the first unified TCI state to the A-CSI-RS resource set or apply the second unified TCI state to the A-CSI-RS resource set.

Example 1000 shows selection of unified TCI states for A-CSI. As shown by reference number 1025, the network entity 1010 may transmit a configuration for at least one A-CSI-RS set. The configuration may be provided in CSI reporting configuration information associated with triggering the A-CSI state (e.g., CSI-AssociatedReportConfigInfo of CSI-AperiodicTriggerState). As shown by reference number 1030, the network entity 1010 may transmit an indication of a first unified TCI state and a second unified TCI state. As shown by reference number 1035, the network entity 1010 may transmit DCI that triggers an A-CSI state.

As shown by reference number 1040, the UE 1020 may apply the first unified TCI state and/or the second unified TCI state to the at least one A-CSI-RS resource set. In some aspects, the configuration may indicate that the UE 1020 is to apply the first unified TCI state or the second unified TCI state to the A-CSI-RS resource set. The at least one A-CSI-RS resource set may be a single A-CSI-RS resource set. In some aspects, if an A-CSI-RS is used for enhanced group-based beam reporting or NCJT CSI measurement, where a CSI report is associated with a first A-CSI-RS resource set and a second A-CSI-RS resource set, the configuration may indicate that both unified TCI states are to be applied. The mapping between unified TCI states and A-CSI-RS sets may be by default, or by sweeping order indications. For example, the first unified TCI state may be applied to the first A-CSI-RS resource set, and the second unified TCI state may be applied to the second A-CSI-RS resource set. By a sweeping order indication, the mapping order may also be switched, where the first unified TCI state may be applied to the second A-CSI-RS resource set, and the second unified TCI state may be applied to the first A-CSI-RS resource set.

In some aspects, the DCI may indicate that the UE 1020 is to apply the first unified TCI state or the second unified TCI state to the A-CSI-RS resource set. The at least one A-CSI-RS resource set may be a single A-CSI-RS resource set. In some aspects, if an A-CSI-RS is used for enhanced group-based beam reporting or NCJT CSI measurement, where a CSI report is associated with a first A-CSI-RS resource set and a second A-CSI-RS resource set, the DCI (e.g., by a TCI field) may indicate that both unified TCI states are to be applied. The mapping between unified TCI states and A-CSI-RS sets may be by default, or by sweeping order indications. For example, the first unified TCI state may be applied to the first A-CSI-RS resource set, and the second unified TCI state may be applied to the second A-CSI-RS resource set. By a sweeping order indication, the mapping order may also be switched, where the first unified TCI state may be applied to the second A-CSI-RS resource set, and the second unified TCI state may be applied to the first A-CSI-RS resource set. As shown by reference number 1045, the network entity 1010 may transmit A-CSI-RSs using the applied unified TCI states, including using the first unified TCI state and/or the second unified TCI state.

In some aspects, the DCI may include multiple DCI for multi-TRP. QCL information may be absent from the CSI reporting configuration associated with triggering the A-CSI state (e.g., CSI-AssociatedReportConfigInfo of CSI-AperiodicTriggerState). In some aspects, a control resource set (CORESET) pool index value (coresetPoolIndex value) may be provided in CSI-AssociatedReportConfigInfo of CSI-AperiodicTriggerState, and the UE 1020 may apply the indicated joint/downlink (DL) TCI state specific to the coresetPoolIndex value to the A-CSI-RS resource set. For example, a CORESET pool index value in the configuration may indicate that the UE 1020 is to apply the first unified TCI state to the one A-CSI-RS resource set or apply the second unified TCI state to the one A-CSI-RS resource set.

In some aspects, the RRC configuration provided in CSI-AssociatedReportConfigInfo of CSI-AperiodicTriggerState for the aperiodic CSI-RS resource set may indicate that the UE 1020 is to apply the first or the second indicated joint/DL TCI state to the aperiodic CSI-RS resource set, where the first and the second indicated joint/DL TCI states correspond to the indicated joint/DL TCI states specific to coresetPoolIndex value 0 and value 1, respectively. For example, the configuration may indicate that the UE 1020 is to apply the first unified TCI state to the one A-CSI-RS resource set based at least in part on a CORESET pool index value of the UE being 0 (zero) or apply the second unified TCI state to the one A-CSI-RS resource set based at least in part on the CORESET pool index value of the UE being 1 (one).

In some aspects, two A-CSI-RS resource sets may be configured to be associated with an A-CSI report configuration (e.g., reportConfig) that is configured with an RRC parameter (e.g., groupBasedBeamReporting-r17). If the one or more A-CSI-RS resources in the first A-CSI-RS resource set are not provided with any QCL information, the first indicated joint/DL TCI state in the single DCI scheduled multi-TRP operation or the indicated joint/DL TCI state specific to a coresetPoolIndex value of 0 in multiple DCI scheduled multi-TRP operation may be applied for the a-CSI-RS resource(s), and if the one or more A-CSI-RS resources in the second A-CSI-RS resource sets are not provided with any QCL information, the second indicated joint/DL TCI state in the single DCI scheduled multi-TRP operation or the joint/DL TCI state specific to a coresetPoolIndex value of 1 in multiple DCI scheduled multi-TRP operation may be applied for the A-CSI-RS resource(s).

In some aspects, one or more resource pairs may be configured by an RRC configuration (e.g. cmrGroupingAndPairing-r17) in a CSI resource set where each resource pair includes two CSI-RS resources. If the first CSI-RS resource in a resource pair is not provided with any QCL information, the first indicated joint/DL TCI state may be applied to the CSI-RS resource, and if the second CSI-RS resource in a resource pair is not provided with any QCL information, the second indicated joint/DL TCI state is applied to the CSI-RS resource.

In some aspects, the UE 1020 may apply the indicated joint/DL TCI state specific to a coresetPoolIndex value to the A-CSI-RS resource set triggered by PDCCH on a CORESET, where the coresetPoolIndex value is determined from the value associated with the CORESET. For example, the configuration may indicate that the UE 1020 is to apply the first unified TCI state to a single A-CSI-RS resource set or apply the second unified TCI state to the A-CSI-RS resource set based at least in part on a CORESET pool index value that corresponds to a CORESET in which the DCI (e.g., in the PDCCH) is received.

In some aspects, a coresetPoolIndex value may be configured per PUCCH resource or per PUCCH resource group, and the UE 1020 may apply the indicated joint/UL TCI state specific to the coresetPoolIndex value to the corresponding PUCCH transmission. In some aspects, an RRC configuration may be provided per PUCCH resource or per PUCCH resource group to indicate that the UE 1020 is to apply the first or the second indicated joint/UL TCI state to the corresponding PUCCH transmission, where the first and the second indicated joint/DL TCI states correspond to the indicated joint/UL TCI states specific to the coresetPoolIndex value of 0 and value 1, respectively. In some aspects, if the UE 1020 is not configured with a joint acknowledgement (ACK)/negative acknowledgement (NACK) feedback (e.g., ackNackFeedbackMode=joint) for multiple DCI based multi-TRP operation, the UE 1020 may apply the indicated joint/UL TCI state specific to a coresetPoolIndex value to the PUCCH transmission triggered by the PDCCH on a CORESET, where the coresetPoolIndex value is determined from the one associated with the CORESET.

As indicated above, FIG. 10 is provided as an example. Other examples may differ from what is described with regard to FIG. 10.

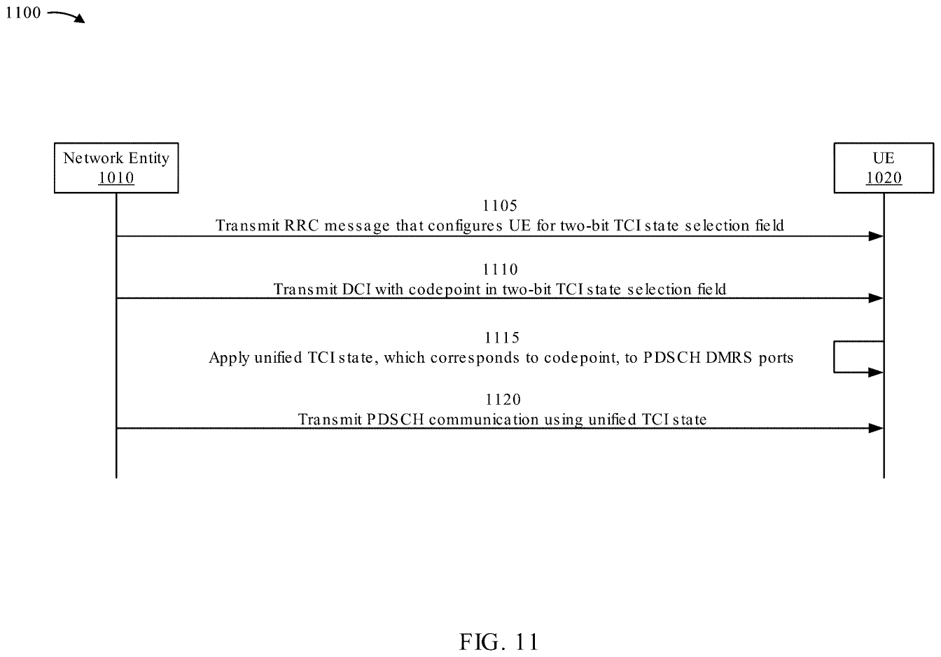

FIG. 11 is a diagram illustrating an example 1100 of TCI state selection for PDSCH, in accordance with the present disclosure.

In some aspects, in a unified TCI framework extension for sDCI based multi-TRP, the network entity 1010 may configure (e.g., via RRC signaling) the UE 1020 to monitor and interpret a TCI selection field (e.g., 2 bits) that is to be present in a DCI format 1_1/1_2 that schedules and/or activates PDSCH reception (e.g., including dynamic PDSCH and semi-persistent scheduling (SPS) PDSCH).

Example 1100 shows the use of a 2-bit TCI selection field. As shown by reference number 1105, the network entity 1010 may transmit an RRC message that configures the UE 1020 for using a 2-bit TCI state selection field. As shown by reference number 1110, the network entity 1010 may transmit DCI with a codepoint in the two-bit TCI state selection field. As shown by reference number 1115, the UE 1020 may apply a unified TCI state, which corresponds to the codepoint, to PDSCH DMRS ports. As shown by reference number 1120, the network entity 1010 may transmit a PDSCH communication using the unified TCI state.

In some aspects, if the DCI format 1_1/1_2 indicates codepoint “00” for the TCI selection field, the UE 1020 may apply the first indicated joint/DL TCI state to all PDSCH DMRS port(s) of all PDSCH transmission occasions(s) scheduled and/or activated by the DCI format 1_1/1_2. If the DCI format 1_1/1_2 indicates codepoint “01” for the TCI selection field, the UE 1020 may apply the second indicated joint/DL TCI state to all PDSCH DMRS port(s) of all PDSCH transmission occasions(s) scheduled and/or activated by the DCI format 1_1/1_2. If the DCI format 1_1/1_2 indicates codepoint “10” for the TCI selection field, the UE 1020 may apply both the first and the second indicated joint/DL TCI states to the PDSCH reception scheduled and/or activated by the DCI format 1_1/1_2.

In some aspects, for a PDSCH TDM scheme with two PDSCH occasions, a PDSCH SDM scheme with two DMRS code division multiplexing (CDM) groups, or a PDSCH FDM scheme with two frequency domain resource allocations (FDRAs), 3GPP standard Release 16 mapping rules may be reused to map the first and the second indicated joint/DL TCI states to PDSCH transmission occasions, CDM groups, or non-overlapping FDRAs by replacing the first and the second indicated legacy TCI states with the first and the second indicated joint/DL TCI states. For example, the UE 1020 may apply the first unified TCI state and the second unified TCI state to the first and second PDSCH occasions, CDM groups, or non-overlapping FDRAs in a first order, based at least in part on the codepoint being a third codepoint value. The UE 1020 may apply the first unified TCI state and the second unified TCI state to the first and second PDSCH occasions, CDM groups, or non-overlapping FDRAs in a second order that is a reverse of the first order, based at least in part on the codepoint being a fourth codepoint value.

For PDSCH SFN or CJT Tx schemes, the UE 1020 may apply both the first and the second indicated joint/DL TCI states to all PDSCH DMRS port(s). If the DCI format 1_1/1_2 indicates codepoint “11” for the TCI selection field, the codepoint may be a reserved codepoint. If the DCI format 1_1/1_2 indicates codepoint “11” for the TCI selection field, for PDSCH TDM/SDM/FDM Tx schemes, Release 16 mapping rules may be reused to map the second and the first indicated joint/DL TCI states to PDSCH transmission occasions, CDM groups, or non-overlapping FDRAs. For example, the UE 1020 may apply the first unified TCI state and the second unified TCI state to the PDSCH DMRS ports based at least in part on the codepoint being a third codepoint value. By using codepoints in a TCI state selection field in DCI, A-CSI-RSs may be more accurate and communications will improve.

In some aspects, the UE 1020 may apply the first indicated joint/DL TCI state to PDSCH reception scheduled or activated by DCI format 1_0 (including dynamic granted PDSCH and semi-persistently scheduled PDSCH) if the UE 1020 is not enabled with the SFN scheme for PDSCH (e.g., not indicated by a RRC parameter sfnSchemePdsch). In some aspects, the UE 1020 may apply both the first and the second indicated joint/DL TCI states to PDSCH reception scheduled/activated by DCI format 1_0 (including dynamic granted PDSCH and semi-persistently scheduled PDSCH) if the UE 1020 is enabled with the SFN scheme for PDSCH (e.g., indicated by an RRC parameter sfnSchemePdsch). In some aspects, the UE 1020 may apply the first indicated joint/UL TCI state to PUSCH transmission scheduled/activated by DCI format 0_0 (including dynamic granted PUSCH and Type-2 configured grant PUSCH).

As indicated above, FIG. 11 is provided as an example. Other examples may differ from what is described with regard to FIG. 11.

FIG. 12 is a diagram illustrating an example process 1200 performed, for example, by a UE, in accordance with the present disclosure. Example process 1200 is an example where the UE (e.g., UE 120, UE 1020) performs operations associated with TCI state selection for A-CSI.

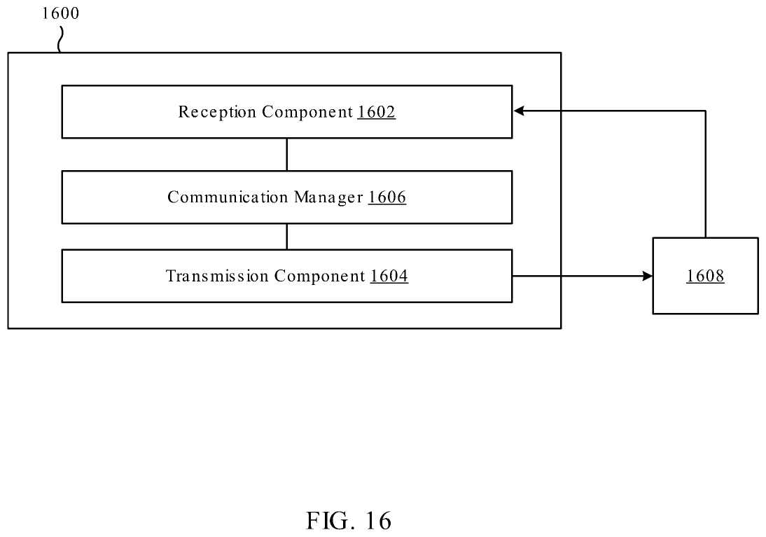

As shown in FIG. 12, in some aspects, process 1200 may include receiving a configuration for at least one A-CSI-RS resource set (block 1210). For example, the UE (e.g., using reception component 1602 and/or communication manager 1606, depicted in FIG. 16) may receive a configuration for at least one A-CSI-RS resource set, as described above.

As further shown in FIG. 12, in some aspects, process 1200 may include receiving an indication of a first unified TCI state and a second unified TCI state (block 1220). For example, the UE (e.g., using reception component 1602 and/or communication manager 1606, depicted in FIG. 16) may receive an indication of a first unified TCI state and a second unified TCI state, as described above.

As further shown in FIG. 12, in some aspects, process 1200 may include receiving DCI that triggers an A-CSI state that is associated with the at least one A-CSI-RS resource set (block 1230). For example, the UE (e.g., using reception component 1602 and/or communication manager 1606, depicted in FIG. 16) may receive DCI that triggers an A-CSI state that is associated with the at least one A-CSI-RS resource set, as described above.

As further shown in FIG. 12, in some aspects, process 1200 may include applying at least one of the first unified TCI state or the second unified TCI state to the at least one A-CSI-RS resource set (block 1240). For example, the UE (e.g., using communication manager 1606, depicted in FIG. 16) may apply at least one of the first unified TCI state or the second unified TCI state to the at least one A-CSI-RS resource set, as described above.

As further shown in FIG. 12, in some aspects, process 1200 may include receiving one or more A-CSI-RSs using the applied at least one of the first unified TCI state or the second unified TCI state (block 1250). For example, the UE (e.g., using reception component 1602 and/or communication manager 1606, depicted in FIG. 16) may receive one or more A-CSI-RSs using the applied at least one of the first unified TCI state or the second unified TCI state, as described above.

Process 1200 may include additional aspects, such as any single aspect or any combination of aspects described below and/or in connection with one or more other processes described elsewhere herein.

In a first aspect, the DCI is a single DCI for multiple TRPs.

In a second aspect, alone or in combination with the first aspect, the configuration includes CSI reporting configuration information associated with triggering the A-CSI state.

In a third aspect, alone or in combination with one or more of the first and second aspects, QCL information is absent in the CSI reporting configuration information.

In a fourth aspect, alone or in combination with one or more of the first through third aspects, the at least one A-CSI-RS resource set includes only one A-CSI-RS resource set, and the configuration indicates that the UE is to apply the first unified TCI state to the one A-CSI-RS resource set or apply the second unified TCI state to the one A-CSI-RS resource set.

In a fifth aspect, alone or in combination with one or more of the first through fourth aspects, the configuration is associated with group-based beam reporting or NCJT CSI measurement, where the at least one A-CSI-RS resource set includes a first A-CSI-RS resource set and a second A-CSI-RS resource set, and the configuration indicates that the UE is to apply the first unified TCI state and the second unified TCI state to the first A-CSI-RS resource set and the second A-CSI-RS resource set based at least in part on a default order for applying TCI states to A-CSI-RS resource sets.

In a sixth aspect, alone or in combination with one or more of the first through fifth aspects, the configuration is associated with group-based beam reporting or NCJT CSI measurement, where the at least one A-CSI-RS resource set includes a first A-CSI-RS resource set and a second A-CSI-RS resource set, and the configuration indicates that the UE is to apply the first unified TCI state and the second unified TCI state to the first A-CSI-RS resource set and the second A-CSI-RS resource set based at least in part on a sweeping order indication.

In a seventh aspect, alone or in combination with one or more of the first through sixth aspects, the sweeping order indication indicates that the UE is to apply the first unified TCI state to the first A-CSI-RS resource set and apply the second unified TCI state to the second A-CSI-RS resource set, or applying the second unified TCI state to the first A-CSI-RS resource set and apply the first unified TCI state to the second A-CSI-RS resource set.

In an eighth aspect, alone or in combination with one or more of the first through seventh aspects, the at least one A-CSI-RS resource set includes only one A-CSI-RS resource set, and the DCI indicates that the UE is to apply the first unified TCI state to the one A-CSI-RS resource set or apply the second unified TCI state to the one A-CSI-RS resource set.

In a ninth aspect, alone or in combination with one or more of the first through eighth aspects, the configuration is associated with group-based beam reporting or NCJT CSI measurement, where the at least one A-CSI-RS resource set includes a first A-CSI-RS resource set and a second A-CSI-RS resource set, and the DCI indicates that the UE is to apply the first unified TCI state and the second unified TCI state to the first A-CSI-RS resource set and the second A-CSI-RS resource set based at least in part on a default order for applying TCI states to A-CSI-RS resource sets.

In a tenth aspect, alone or in combination with one or more of the first through ninth aspects, the configuration is associated with group-based beam reporting or NCJT CSI measurement, where the at least one A-CSI-RS resource set includes a first A-CSI-RS resource set and a second A-CSI-RS resource set, and the DCI indicates that the UE is to apply the first unified TCI state and the second unified TCI state to the first A-CSI-RS resource set and the second A-CSI-RS resource set based at least in part on a sweeping order indication.

In an eleventh aspect, alone or in combination with one or more of the first through tenth aspects, the sweeping order indication indicates that the UE is to apply the first unified TCI state to the first A-CSI-RS resource set and apply the second unified TCI state to the second A-CSI-RS resource set, or apply the second unified TCI state to the first A-CSI-RS resource set and apply the first unified TCI state to the second A-CSI-RS resource set.

In a twelfth aspect, alone or in combination with one or more of the first through eleventh aspects, the DCI includes multiple DCI for multiple TRPs.

In a thirteenth aspect, alone or in combination with one or more of the first through twelfth aspects, the at least one A-CSI-RS resource set includes only one A-CSI-RS resource set, and a CORESET pool index value in the configuration indicates that the UE is to apply the first unified TCI state to the one A-CSI-RS resource set or apply the second unified TCI state to the one A-CSI-RS resource set.

In a fourteenth aspect, alone or in combination with one or more of the first through thirteenth aspects, the at least one A-CSI-RS resource set includes only one A-CSI-RS resource set, and the configuration indicates that the UE is to apply the first unified TCI state to the one A-CSI-RS resource set based at least in part on a CORESET pool index value of the UE being zero and apply the second unified TCI state to the one A-CSI-RS resource set based at least in part on the CORESET pool index value of the UE being one.

In a fifteenth aspect, alone or in combination with one or more of the first through fourteenth aspects, the at least one A-CSI-RS resource set includes only one A-CSI-RS resource set, and the configuration indicates that the UE is to apply the first unified TCI state to the one A-CSI-RS resource set or apply the second unified TCI state to the one A-CSI-RS resource set based at least in part on a CORESET pool index value that corresponds to a CORESET in which the DCI is received.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a network entity, in accordance with the present disclosure. Example process 1300 is an example where the network entity (e.g., network node 110, network entity 1010) performs operations associated with TCI state selection for A-CSI.

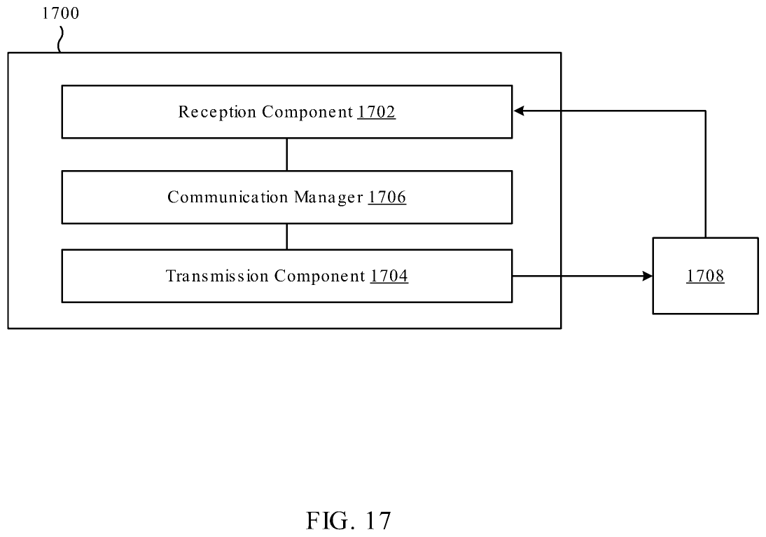

As shown in FIG. 13, in some aspects, process 1300 may include transmitting a configuration for at least one A-CSI-RS resource set (block 1310). For example, the network entity (e.g., using transmission component 1704 and/or communication manager 1706, depicted in FIG. 17) may transmit a configuration for at least one A-CSI-RS resource set, as described above.

As further shown in FIG. 13, in some aspects, process 1300 may include transmitting an indication of a first unified TCI state and a second unified TCI state (block 1320). For example, the network entity (e.g., using transmission component 1704 and/or communication manager 1706, depicted in FIG. 17) may transmit an indication of a first unified TCI state and a second unified TCI state, as described above.

As further shown in FIG. 13, in some aspects, process 1300 may include transmitting DCI that triggers an A-CSI state that is associated with the at least one A-CSI-RS resource set (block 1330). For example, the network entity (e.g., using transmission component 1704 and/or communication manager 1706, depicted in FIG. 17) may transmit DCI that triggers an A-CSI state that is associated with the at least one A-CSI-RS resource set, as described above.

As further shown in FIG. 13, in some aspects, process 1300 may include applying at least one of the first unified TCI state or the second unified TCI state to the at least one A-CSI-RS resource set (block 1340). For example, the network entity (e.g., using communication manager 1706, depicted in FIG. 17) may apply at least one of the first unified TCI state or the second unified TCI state to the at least one A-CSI-RS resource set, as described above.

As further shown in FIG. 13, in some aspects, process 1300 may include transmitting one or more A-CSI-RSs using one or more applied unified TCI states (block 1350). For example, the network entity (e.g., using transmission component 1704 and/or communication manager 1706, depicted in FIG. 17) may transmit one or more A-CSI-RSs using one or more applied unified TCI states, as described above.

Process 1300 may include additional aspects, such as any single aspect or any combination of aspects described below and/or in connection with one or more other processes described elsewhere herein.

In a first aspect, the at least one A-CSI-RS resource set includes only one A-CSI-RS resource set, and the configuration indicates that a UE is to apply the first unified TCI state to the one A-CSI-RS resource set or apply the second unified TCI state to the one A-CSI-RS resource set.

In a second aspect, alone or in combination with the first aspect, the configuration is associated with group-based beam reporting or NCJT CSI measurement, where the at least one A-CSI-RS resource set includes a first A-CSI-RS resource set and a second A-CSI-RS resource set, and the configuration indicates that a UE is to apply the first unified TCI state and the second unified TCI state to the first A-CSI-RS resource set and the second A-CSI-RS resource set based at least in part on a default order or a beam sweeping indication order for applying TCI states to A-CSI-RS resource sets.

In a third aspect, alone or in combination with one or more of the first and second aspects, the at least one A-CSI-RS resource set includes only one A-CSI-RS resource set, and the DCI indicates that a UE is to apply the first unified TCI state to the one A-CSI-RS resource set or apply the second unified TCI state to the one A-CSI-RS resource set.

In a fourth aspect, alone or in combination with one or more of the first through third aspects, the configuration is associated with group-based beam reporting or NCJT CSI measurement, where the at least one A-CSI-RS resource set includes a first A-CSI-RS resource set and a second A-CSI-RS resource set, and the DCI indicates that a UE is to apply the first unified TCI state and the second unified TCI state to the first A-CSI-RS resource set and the second A-CSI-RS resource set based at least in part on a default order or a beam sweeping order for applying TCI states to A-CSI-RS resource sets.

In a fifth aspect, alone or in combination with one or more of the first through fourth aspects, the at least one A-CSI-RS resource set includes only one A-CSI-RS resource set, and a CORESET pool index value in the configuration indicates that a UE is to apply the first unified TCI state to the one A-CSI-RS resource set or apply the second unified TCI state to the one A-CSI-RS resource set.

In a sixth aspect, alone or in combination with one or more of the first through fifth aspects, the at least one A-CSI-RS resource set includes only one A-CSI-RS resource set, and the configuration indicates that a UE is to apply the first unified TCI state to the one A-CSI-RS resource set based at least in part on a CORESET pool index value of the UE being zero and apply the second unified TCI state to the one A-CSI-RS resource set based at least in part on the CORESET pool index value of the UE being one.

In a seventh aspect, alone or in combination with one or more of the first through sixth aspects, the at least one A-CSI-RS resource set includes only one A-CSI-RS resource set, and the configuration indicates that a UE is to apply the first unified TCI state to the one A-CSI-RS resource set or apply the second unified TCI state to the one A-CSI-RS resource set based at least in part on a CORESET pool index value that corresponds to a CORESET in which the DCI is received.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a UE, in accordance with the present disclosure. Example process 1400 is an example where the UE (e.g., UE 120, UE 1020) performs operations associated with TCI state selection for PDSCH.

As shown in FIG. 14, in some aspects, process 1400 may include receiving an RRC message that configures the UE for receiving a two-bit TCI state selection field (block 1410). For example, the UE (e.g., using reception component 1602 and/or communication manager 1606, depicted in FIG. 16) may receive an RRC message that configures the UE for receiving a two-bit TCI state selection field, as described above.

As further shown in FIG. 14, in some aspects, process 1400 may include receiving DCI that includes a codepoint in the two-bit TCI state selection field (block 1420). For example, the UE (e.g., using reception component 1602 and/or communication manager 1606, depicted in FIG. 16) may receive DCI that includes a codepoint in the two-bit TCI state selection field, as described above.

As further shown in FIG. 14, in some aspects, process 1400 may include applying a unified TCI state, which corresponds to the codepoint, to PDSCH DMRS ports for PDSCH occasions scheduled or activated by the DCI (block 1430). For example, the UE (e.g., using communication manager 1606, depicted in FIG. 16) may apply a unified TCI state, which corresponds to the codepoint, to PDSCH DMRS ports for PDSCH occasions scheduled or activated by the DCI, as described above.

As further shown in FIG. 14, in some aspects, process 1400 may include receiving a PDSCH communication using the unified TCI state (block 1440). For example, the UE (e.g., using reception component 1602 and/or communication manager 1606, depicted in FIG. 16) may receive a PDSCH communication using the unified TCI state, as described above.

Process 1400 may include additional aspects, such as any single aspect or any combination of aspects described below and/or in connection with one or more other processes described elsewhere herein.

In a first aspect, the UE is configured for a TDM scheme, an SDM scheme, or an FDM scheme, and applying the unified TCI state includes applying a first unified TCI state to the PDSCH DMRS ports based at least in part on the codepoint being a first codepoint value, applying a second unified TCI state to the PDSCH DMRS ports based at least in part on the codepoint being a second codepoint value, applying the first unified TCI state and the second unified TCI state to PDSCH occasions, CDM groups, or non-overlapping FDRAs in a first order, based at least in part on the codepoint being a third codepoint value, or applying the first unified TCI state and the second unified TCI state to PDSCH occasions, CDM groups, or non-overlapping FDRAs in a second order that is a reverse of the first order, based at least in part on the codepoint being a fourth codepoint value.

In a second aspect, alone or in combination with the first aspect, the UE is configured for an SFN scheme or a CJT scheme, and applying the unified TCI state includes applying a first unified TCI state to the PDSCH DMRS ports based at least in part on the codepoint being a first codepoint value, applying a second unified TCI state to the PDSCH DMRS ports based at least in part on the codepoint being a second codepoint value, or applying the first unified TCI state and the second unified TCI state to the PDSCH DMRS ports based at least in part on the codepoint being a third codepoint value.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, by a network entity, in accordance with the present disclosure. Example process 1500 is an example where the network entity (e.g., network node 110, network entity 1010) performs operations associated with TCI state selection for PDSCH.

As shown in FIG. 15, in some aspects, process 1500 may include transmitting an RRC message that configures a UE for receiving a two-bit TCI state selection field (block 1510). For example, the network entity (e.g., using transmission component 1704 and/or communication manager 1706, depicted in FIG. 17) may transmit an RRC message that configures a UE for receiving a two-bit TCI state selection field, as described above.

As further shown in FIG. 15, in some aspects, process 1500 may include transmitting DCI that includes a codepoint in the two-bit TCI state selection field (block 1520). For example, the network entity (e.g., using transmission component 1704 and/or communication manager 1706, depicted in FIG. 17) may transmit DCI that includes a codepoint in the two-bit TCI state selection field, as described above.

As further shown in FIG. 15, in some aspects, process 1500 may include applying a unified TCI state, which corresponds to the codepoint, to PDSCH DMRS ports for PDSCH occasions scheduled or activated by the DCI (block 1530). For example, the network entity (e.g., using communication manager 1706, depicted in FIG. 17) may apply a unified TCI state, which corresponds to the codepoint, to PDSCH

DMRS ports for PDSCH occasions scheduled or activated by the DCI, as described above.

As further shown in FIG. 15, in some aspects, process 1500 may include transmitting a PDSCH communication using the unified TCI state (block 1540). For example, the network entity (e.g., using transmission component 1704 and/or communication manager 1706, depicted in FIG. 17) may transmit a PDSCH communication using the unified TCI state, as described above.

Process 1500 may include additional aspects, such as any single aspect or any combination of aspects described below and/or in connection with one or more other processes described elsewhere herein.

In a first aspect, the DCI is for a TDM scheme, an SDM scheme, or an FDM scheme, and applying the unified TCI state includes applying a first unified TCI state to the PDSCH DMRS ports based at least in part on the codepoint being a first codepoint value, applying a second unified TCI state to the PDSCH DMRS ports based at least in part on the codepoint being a second codepoint value, applying the first unified TCI state and the second unified TCI state to PDSCH occasions, CDM groups, or non-overlapping FDRAs in a first order, based at least in part on the codepoint being a third codepoint value, or applying the first unified TCI state and the second unified TCI state to PDSCH occasions, CDM groups, or non-overlapping FDRAs in a second order that is a reverse of the first order, based at least in part on the codepoint being a fourth codepoint value.

In a second aspect, alone or in combination with the first aspect, the DCI is for an SFN scheme or a CJT scheme, and applying the unified TCI state includes applying a first unified TCI state to the PDSCH DMRS ports based at least in part on the codepoint being a first codepoint value, applying a second unified TCI state to the PDSCH DMRS ports based at least in part on the codepoint being a second codepoint value, or applying the first unified TCI state and the second unified TCI state to the PDSCH DMRS ports based at least in part on the codepoint being a third codepoint value.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram of an example apparatus 1600 for wireless communication, in accordance with the present disclosure. The apparatus 1600 may be a UE (e.g., UE 120, UE 1020), or a UE may include the apparatus 1600. In some aspects, the apparatus 1600 includes a reception component 1602, a transmission component 1604, and/or a communication manager 1606, which may be in communication with one another (for example, via one or more buses and/or one or more other components). In some aspects, the communication manager 1606 is the communication manager 140 described in connection with FIG. 1. As shown, the apparatus 1600 may communicate with another apparatus 1608, such as a UE or a network node (such as a CU, a DU, an RU, or a base station), using the reception component 1602 and the transmission component 1604.

In some aspects, the apparatus 1600 may be configured to perform one or more operations described herein in connection with FIGS. 1-11. Additionally, or alternatively, the apparatus 1600 may be configured to perform one or more processes described herein, such as process 1200 of FIG. 12, process 1400 of FIG. 14, or a combination thereof. In some aspects, the apparatus 1600 and/or one or more components shown in FIG. 16 may include one or more components of the UE described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the UE described in connection with FIG. 2.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1608. In some aspects, the transmission component 1604 may include one or more antennas, a modem, a modulator, a transmit MIMO processor, a transmit processor, a controller/processor, a memory, or a combination thereof, of the UE described in connection with FIG. 2. In some aspects, the transmission component 1604 may be co-located with the reception component 1602 in a transceiver.

The communication manager 1606 may support operations of the reception component 1602 and/or the transmission component 1604. For example, the communication manager 1606 may receive information associated with configuring reception of communications by the reception component 1602 and/or transmission of communications by the transmission component 1604. Additionally, or alternatively, the communication manager 1606 may generate and/or provide control information to the reception component 1602 and/or the transmission component 1604 to control reception and/or transmission of communications.

In some aspects associated with A-CSI, the reception component 1602 may receive a configuration for at least one A-CSI-RS resource set. The reception component 1602 may receive an indication of a first unified TCI state and a second unified TCI state. The reception component 1602 may receive DCI that triggers an A-CSI state that is associated with the at least one A-CSI-RS resource set. The communication manager 1606 may apply at least one of the first unified TCI state or the second unified TCI state to the at least one A-CSI-RS resource set. The reception component 1602 may receive one or more A-CSI-RSs using the applied at least one of the first unified TCI state or the second unified TCI state.

In some aspects associated with PDSCH, the reception component 1602 may receive an RRC message that configures the UE for receiving a two-bit TCI state selection field. The reception component 1602 may receive DCI that includes a codepoint in the two-bit TCI state selection field. The communication manager 1606 may apply a unified TCI state, which corresponds to the codepoint, to PDSCH DMRS ports for PDSCH occasions scheduled or activated by the DCI. The reception component 1602 may receive a PDSCH communication using the unified TCI state.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

FIG. 17 is a diagram of an example apparatus 1700 for wireless communication, in accordance with the present disclosure. The apparatus 1700 may be a network entity (e.g., network node 110, network entity 1010), or a network entity may include the apparatus 1700. In some aspects, the apparatus 1700 includes a reception component 1702, a transmission component 1704, and/or a communication manager 1706, which may be in communication with one another (for example, via one or more buses and/or one or more other components). In some aspects, the communication manager 1706 is the communication manager 150 described in connection with FIG. 1. As shown, the apparatus 1700 may communicate with another apparatus 1708, such as a UE or a network node (such as a CU, a DU, an RU, or a base station), using the reception component 1702 and the transmission component 1704.

In some aspects, the apparatus 1700 may be configured to perform one or more operations described herein in connection with FIGS. 1-11. Additionally, or alternatively, the apparatus 1700 may be configured to perform one or more processes described herein, such as process 1300 of FIG. 13, process 1500 of FIG. 15, or a combination thereof. In some aspects, the apparatus 1700 and/or one or more components shown in FIG. 17 may include one or more components of the network entity described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1702 may receive communications, such as reference signals, control information, data communications, or a combination thereof, from the apparatus 1708. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, a modem, a demodulator, a MIMO detector, a receive processor, a controller/processor, a memory, or a combination thereof, of the network entity described in connection with FIG. 2.

The transmission component 1704 may transmit communications, such as reference signals, control information, data communications, or a combination thereof, to the apparatus 1708. In some aspects, one or more other components of the apparatus 1700 may generate communications and may provide the generated communications to the transmission component 1704 for transmission to the apparatus 1708. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1708. In some aspects, the transmission component 1704 may include one or more antennas, a modem, a modulator, a transmit MIMO processor, a transmit processor, a controller/processor, a memory, or a combination thereof, of the network entity described in connection with FIG. 2. In some aspects, the transmission component 1704 may be co-located with the reception component 1702 in a transceiver.

The communication manager 1706 may support operations of the reception component 1702 and/or the transmission component 1704. For example, the communication manager 1706 may receive information associated with configuring reception of communications by the reception component 1702 and/or transmission of communications by the transmission component 1704. Additionally, or alternatively, the communication manager 1706 may generate and/or provide control information to the reception component 1702 and/or the transmission component 1704 to control reception and/or transmission of communications.

In some aspects associated with A-CSI, the transmission component 1704 may transmit a configuration for at least one A-CSI-RS resource set. The transmission component 1704 may transmit an indication of a first unified TCI state and a second unified TCI state. The transmission component 1704 may transmit DCI that triggers an A-CSI state that is associated with the at least one A-CSI-RS resource set. The communication manager 1706 may apply at least one of the first unified TCI state or the second unified TCI state to the at least one A-CSI-RS resource set. The transmission component 1704 may transmit one or more A-CSI-RSs using one or more applied unified TCI states.

In some aspects associated with PDSCH, the transmission component 1704 may transmit an RRC message that configures a UE for receiving a two-bit TCI state selection field. The transmission component 1704 may transmit DCI that includes a codepoint in the two-bit TCI state selection field. The communication manager 1706 may apply a unified TCI state, which corresponds to the codepoint, to PDSCH DMRS ports for PDSCH occasions scheduled or activated by the DCI. The transmission component 1704 may transmit a PDSCH communication using the unified TCI state.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

The following provides an overview of some Aspects of the present disclosure:
Aspect 1: A method of wireless communication performed by a user equipment (UE), comprising: receiving a configuration for at least one aperiodic channel state information (CSI) reference signal (A-CSI-RS) resource set; receiving an indication of a first unified transmission configuration indicator (TCI) state and a second unified TCI state; receiving downlink control information (DCI) that triggers an aperiodic CSI (A-CSI) state that is associated with the at least one A-CSI-RS resource set; applying at least one of the first unified TCI state or the second unified TCI state to the at least one A-CSI-RS resource set; and receiving one or more A-CSI-RSs using the applied at least one of the first unified TCI state or the second unified TCI state.
Aspect 2: The method of Aspect 1, wherein the DCI is a single DCI for multiple transmit receive points.
Aspect 3: The method of Aspect 2, wherein the configuration includes CSI reporting configuration information associated with triggering the A-CSI state.
Aspect 4: The method of Aspect 3, wherein quasi-co-location information is absent in the CSI reporting configuration information.
Aspect 5: The method of Aspect 2 or 3, wherein the at least one A-CSI-RS resource set includes only one A-CSI-RS resource set, and wherein the configuration indicates that the UE is to apply the first unified TCI state to the one A-CSI-RS resource set or apply the second unified TCI state to the one A-CSI-RS resource set.
Aspect 6: The method of Aspect 2 or 3, wherein the configuration is associated with group-based beam reporting or non-coherent joint transmission CSI measurement, wherein the at least one A-CSI-RS resource set includes a first A-CSI-RS resource set and a second A-CSI-RS resource set, and wherein the configuration indicates that the UE is to apply the first unified TCI state and the second unified TCI state to the first A-CSI-RS resource set and the second A-CSI-RS resource set based at least in part on a default order for applying TCI states to A-CSI-RS resource sets.
Aspect 7: The method of Aspect 2 or 3, wherein the configuration is associated with group-based beam reporting or non-coherent joint transmission CSI measurement, wherein the at least one A-CSI-RS resource set includes a first A-CSI-RS resource set and a second A-CSI-RS resource set, and wherein the configuration indicates that the UE is to apply the first unified TCI state and the second unified TCI state to the first A-CSI-RS resource set and the second A-CSI-RS resource set based at least in part on a sweeping order indication.
Aspect 8: The method of Aspect 7, wherein the sweeping order indication indicates that the UE is to: apply the first unified TCI state to the first A-CSI-RS resource set and apply the second unified TCI state to the second A-CSI-RS resource set, or apply the second unified TCI state to the first A-CSI-RS resource set and apply the first unified TCI state to the second A-CSI-RS resource set.
Aspect 9: The method of Aspect 2 or 3, wherein the at least one A-CSI-RS resource set includes only one A-CSI-RS resource set, and wherein the DCI indicates that the UE is to apply the first unified TCI state to the one A-CSI-RS resource set or apply the second unified TCI state to the one A-CSI-RS resource set.
Aspect 10: The method of Aspect 2 or 3, wherein the configuration is associated with group-based beam reporting or non-coherent joint transmission CSI measurement, wherein the at least one A-CSI-RS resource set includes a first A-CSI-RS resource set and a second A-CSI-RS resource set, and wherein the DCI indicates that the UE is to apply the first unified TCI state and the second unified TCI state to the first A-CSI-RS resource set and the second A-CSI-RS resource set based at least in part on a default order for applying TCI states to A-CSI-RS resource sets.
Aspect 11: The method of Aspect 2 or 3, wherein the configuration is associated with group-based beam reporting or non-coherent joint transmission CSI measurement, wherein the at least one A-CSI-RS resource set includes a first A-CSI-RS resource set and a second A-CSI-RS resource set, and wherein the DCI indicates that the UE is to apply the first unified TCI state and the second unified TCI state to the first A-CSI-RS resource set and the second A-CSI-RS resource set based at least in part on a sweeping order indication.
Aspect 12: The method of Aspect 11, wherein the sweeping order indication indicates that the UE is to: apply the first unified TCI state to the first A-CSI-RS resource set and apply the second unified TCI state to the second A-CSI-RS resource set, or apply the second unified TCI state to the first A-CSI-RS resource set and apply the first unified TCI state to the second A-CSI-RS resource set.
Aspect 13: The method of Aspect 1, wherein the DCI includes multiple DCI for multiple transmit receive points.
Aspect 14: The method of Aspect 13, wherein the at least one A-CSI-RS resource set includes only one A-CSI-RS resource set, and wherein a control resource set (CORESET) pool index value in the configuration indicates that the UE is to apply the first unified TCI state to the one A-CSI-RS resource set or apply the second unified TCI state to the one A-CSI-RS resource set.
Aspect 15: The method of Aspect 13, wherein the at least one A-CSI-RS resource set includes only one A-CSI-RS resource set, and wherein the configuration indicates that the UE is to apply the first unified TCI state to the one A-CSI-RS resource set based at least in part on a control resource set (CORESET) pool index value of the UE being zero and apply the second unified TCI state to the one A-CSI-RS resource set based at least in part on the CORESET pool index value of the UE being one.
Aspect 16: The method of Aspect 13, wherein the at least one A-CSI-RS resource set includes only one A-CSI-RS resource set, and wherein the configuration indicates that the UE is to apply the first unified TCI state to the one A-CSI-RS resource set or apply the second unified TCI state to the one A-CSI-RS resource set based at least in part on a control resource set (CORESET) pool index value that corresponds to a CORESET in which the DCI is received.
Aspect 17: A method of wireless communication performed by a network entity, comprising: transmitting a configuration for at least one aperiodic channel state information (CSI) reference signal (A-CSI-RS) resource set; transmitting an indication of a first unified transmission configuration indicator (TCI) state and a second unified TCI state; transmitting downlink control information (DCI) that triggers an A-CSI state that is associated with the at least one A-CSI-RS resource set; applying at least one of the first unified TCI state or the second unified TCI state to the at least one A-CSI-RS resource set; and transmitting one or more A-CSI-RSs using one or more applied unified TCI states.
Aspect 18: The method of Aspect 17, wherein the at least one A-CSI-RS resource set includes only one A-CSI-RS resource set, and wherein the configuration indicates that a user equipment is to apply the first unified TCI state to the one A-CSI-RS resource set or apply the second unified TCI state to the one A-CSI-RS resource set.
Aspect 19: The method of Aspect 17, wherein the configuration is associated with group-based beam reporting or non-coherent joint transmission CSI measurement, wherein the at least one A-CSI-RS resource set includes a first A-CSI-RS resource set and a second A-CSI-RS resource set, and wherein the configuration indicates that a user equipment is to apply the first unified TCI state and the second unified TCI state to the first A-CSI-RS resource set and the second A-CSI-RS resource set based at least in part on a default order or a beam sweeping indication order for applying TCI states to A-CSI-RS resource sets.
Aspect 20: The method of Aspect 17, wherein the at least one A-CSI-RS resource set includes only one A-CSI-RS resource set, and wherein the DCI indicates that a user equipment is to apply the first unified TCI state to the one A-CSI-RS resource set or apply the second unified TCI state to the one A-CSI-RS resource set.
Aspect 21: The method of Aspect 17, wherein the configuration is associated with group-based beam reporting or non-coherent joint transmission CSI measurement, wherein the at least one A-CSI-RS resource set includes a first A-CSI-RS resource set and a second A-CSI-RS resource set, and wherein the DCI indicates that a user equipment is to apply the first unified TCI state and the second unified TCI state to the first A-CSI-RS resource set and the second A-CSI-RS resource set based at least in part on a default order or a beam sweeping order for applying TCI states to A-CSI-RS resource sets.
Aspect 22: The method of Aspect 17, wherein the at least one A-CSI-RS resource set includes only one A-CSI-RS resource set, and wherein a control resource set (CORESET) pool index value in the configuration indicates that a user equipment is to apply the first unified TCI state to the one A-CSI-RS resource set or apply the second unified TCI state to the one A-CSI-RS resource set.
Aspect 23: The method of Aspect 17, wherein the at least one A-CSI-RS resource set includes only one A-CSI-RS resource set, and wherein the configuration indicates that a user equipment is to apply the first unified TCI state to the one A-CSI-RS resource set based at least in part on a control resource set (CORESET) pool index value of the UE being zero and apply the second unified TCI state to the one A-CSI-RS resource set based at least in part on the CORESET pool index value of the UE being one.
Aspect 24: The method of Aspects 17, wherein the at least one A-CSI-RS resource set includes only one A-CSI-RS resource set, and wherein the configuration indicates that a user equipment is to apply the first unified TCI state to the one A-CSI-RS resource set or apply the second unified TCI state to the one A-CSI-RS resource set based at least in part on a control resource set (CORESET) pool index value that corresponds to a CORESET in which the DCI is received.
Aspect 25: A method of wireless communication performed by a user equipment (UE), comprising: receiving a radio resource control (RRC) message that configures the UE for receiving a two-bit transmission configuration indicator (TCI) state selection field; receiving downlink control information (DCI) that includes a codepoint in the two-bit TCI state selection field; applying a unified TCI state, which corresponds to the codepoint, to physical downlink shared channel (PDSCH) demodulation reference signal (DMRS) ports for PDSCH occasions scheduled or activated by the DCI; and receiving a PDSCH communication using the unified TCI state.
Aspect 26: The method of Aspect 25, wherein the UE is configured for a time division multiplexing scheme, a spatial division multiplexing scheme, or a frequency division multiplexing scheme, and wherein applying the unified TCI state includes: applying a first unified TCI state to the PDSCH DMRS ports based at least in part on the codepoint being a first codepoint value, applying a second unified TCI state to the PDSCH DMRS ports based at least in part on the codepoint being a second codepoint value, applying the first unified TCI state and the second unified TCI state to PDSCH occasions, code division multiplexing (CDM) groups, or non-overlapping frequency domain resource allocations in a first order, based at least in part on the codepoint being a third codepoint value, or applying the first unified TCI state and the second unified TCI state to PDSCH occasions, code division multiplexing (CDM) groups, or non-overlapping frequency domain resource allocations in a second order that is a reverse of the first order, based at least in part on the codepoint being a fourth codepoint value.
Aspect 27: The method of Aspect 25, wherein the UE is configured for a single-frequency network scheme or a coherent joint transmission scheme, and wherein applying the unified TCI state includes: applying a first unified TCI state to the PDSCH DMRS ports based at least in part on the codepoint being a first codepoint value, applying a second unified TCI state to the PDSCH DMRS ports based at least in part on the codepoint being a second codepoint value, or applying the first unified TCI state and the second unified TCI state to the PDSCH DMRS ports based at least in part on the codepoint being a third codepoint value.
Aspect 28: A method of wireless communication performed by a network entity, comprising: transmitting a radio resource control (RRC) message that configures a user equipment (UE) for receiving a two-bit transmission configuration indicator (TCI) state selection field; transmitting downlink control information (DCI) that includes a codepoint in the two-bit TCI state selection field; applying a unified TCI state, which corresponds to the codepoint, to physical downlink shared channel (PDSCH) demodulation reference signal (DMRS) ports for PDSCH occasions scheduled or activated by the DCI; and transmitting a PDSCH communication using the unified TCI state.
Aspect 29: The method of Aspect 28, wherein the DCI is for a time division multiplexing scheme, a spatial division multiplexing scheme, or a frequency division multiplexing scheme, and wherein applying the unified TCI state includes: applying a first unified TCI state to the PDSCH DMRS ports based at least in part on the codepoint being a first codepoint value, applying a second unified TCI state to the PDSCH DMRS ports based at least in part on the codepoint being a second codepoint value, applying the first unified TCI state and the second unified TCI state to PDSCH occasions, code division multiplexing (CDM) groups, or non-overlapping frequency domain resource allocations in a first order, based at least in part on the codepoint being a third codepoint value, or applying the first unified TCI state and the second unified TCI state to PDSCH occasions, code division multiplexing (CDM) groups, or non-overlapping frequency domain resource allocations in a second order that is a reverse of the first order, based at least in part on the codepoint being a fourth codepoint value.
Aspect 30: The method of Aspect 28, wherein the DCI is for a single-frequency network scheme or a coherent joint transmission scheme, and wherein applying the unified TCI state includes: applying a first unified TCI state to the PDSCH DMRS ports based at least in part on the codepoint being a first codepoint value, applying a second unified TCI state to the PDSCH DMRS ports based at least in part on the codepoint being a second codepoint value, or applying the first unified TCI state and the second unified TCI state to the PDSCH DMRS ports based at least in part on the codepoint being a third codepoint value.
Aspect 31: An apparatus for wireless communication at a device, comprising a processor; memory coupled with the processor; and instructions stored in the memory and executable by the processor to cause the apparatus to perform the method of one or more of Aspects 1-30.
Aspect 32: A device for wireless communication, comprising a memory and one or more processors coupled to the memory, the one or more processors configured to perform the method of one or more of Aspects 1-30.
Aspect 33: An apparatus for wireless communication, comprising at least one means for performing the method of one or more of Aspects 1-30.
Aspect 34: A non-transitory computer-readable medium storing code for wireless communication, the code comprising instructions executable by a processor to perform the method of one or more of Aspects 1-30.
Aspect 35: A non-transitory computer-readable medium storing a set of instructions for wireless communication, the set of instructions comprising one or more instructions that, when executed by one or more processors of a device, cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
receive a configuration for at least one aperiodic channel state information (CSI) reference signal (A-CSI-RS) resource set;
receive an indication of a first unified transmission configuration indicator (TCI) state and a second unified TCI state;
receive downlink control information (DCI) that triggers an aperiodic CSI (A-CSI) state that is associated with the at least one A-CSI-RS resource set;
apply at least one of the first unified TCI state or the second unified TCI state to the at least one A-CSI-RS resource set; and
receive one or more A-CSI-RSs using the applied at least one of the first unified TCI state or the second unified TCI state.

2. The UE of claim 1, wherein the DCI is a single DCI for multiple transmit receive points.

3. The UE of claim 2, wherein the configuration includes CSI reporting configuration information associated with triggering the A-CSI state.

4. The UE of claim 3, wherein quasi-co-location information is absent in the CSI reporting configuration information.

5. The UE of claim 2, wherein the at least one A-CSI-RS resource set includes only one A-CSI-RS resource set, and wherein the configuration indicates that the UE is to apply the first unified TCI state to the one A-CSI-RS resource set or apply the second unified TCI state to the one A-CSI-RS resource set.

6. The UE of claim 2, wherein the configuration is associated with group-based beam reporting or non-coherent joint transmission CSI measurement, wherein the at least one A-CSI-RS resource set includes a first A-CSI-RS resource set and a second A-CSI-RS resource set, and wherein the configuration indicates that the UE is to apply the first unified TCI state and the second unified TCI state to the first A-CSI-RS resource set and the second A-CSI-RS resource set based at least in part on a default order for applying TCI states to A-CSI-RS resource sets.

7. The UE of claim 2, wherein the configuration is associated with group-based beam reporting or non-coherent joint transmission CSI measurement, wherein the at least one A-CSI-RS resource set includes a first A-CSI-RS resource set and a second A-CSI-RS resource set, and wherein the configuration indicates that the UE is to apply the first unified TCI state and the second unified TCI state to the first A-CSI-RS resource set and the second A-CSI-RS resource set based at least in part on a sweeping order indication.

8. The UE of claim 7, wherein the sweeping order indication indicates that the UE is to:
apply the first unified TCI state to the first A-CSI-RS resource set and apply the second unified TCI state to the second A-CSI-RS resource set, or
apply the second unified TCI state to the first A-CSI-RS resource set and apply the first unified TCI state to the second A-CSI-RS resource set.

9. The UE of claim 2, wherein the at least one A-CSI-RS resource set includes only one A-CSI-RS resource set, and wherein the DCI indicates that the UE is to apply the first unified TCI state to the one A-CSI-RS resource set or apply the second unified TCI state to the one A-CSI-RS resource set.

10. The UE of claim 2, wherein the configuration is associated with group-based beam reporting or non-coherent joint transmission CSI measurement, wherein the at least one A-CSI-RS resource set includes a first A-CSI-RS resource set and a second A-CSI-RS resource set, and wherein the DCI indicates that the UE is to apply the first unified TCI state and the second unified TCI state to the first A-CSI-RS resource set and the second A-CSI-RS resource set based at least in part on a default order for applying TCI states to A-CSI-RS resource sets.

11. The UE of claim 2, wherein the configuration is associated with group-based beam reporting or non-coherent joint transmission CSI measurement, wherein the at least one A-CSI-RS resource set includes a first A-CSI-RS resource set and a second A-CSI-RS resource set, and wherein the DCI indicates that the UE is to apply the first unified TCI state and the second unified TCI state to the first A-CSI-RS resource set and the second A-CSI-RS resource set based at least in part on a sweeping order indication.

12. The UE of claim 11, wherein the sweeping order indication indicates that the UE is to:
apply the first unified TCI state to the first A-CSI-RS resource set and apply the second unified TCI state to the second A-CSI-RS resource set, or
apply the second unified TCI state to the first A-CSI-RS resource set and apply the first unified TCI state to the second A-CSI-RS resource set.

13. The UE of claim 1, wherein the DCI includes multiple DCI for multiple transmit receive points.

14. The UE of claim 13, wherein the at least one A-CSI-RS resource set includes only one A-CSI-RS resource set, and wherein a control resource set (CORESET) pool index value in the configuration indicates that the UE is to apply the first unified TCI state to the one A-CSI-RS resource set or apply the second unified TCI state to the one A-CSI-RS resource set.

15. The UE of claim 13, wherein the at least one A-CSI-RS resource set includes only one A-CSI-RS resource set, and wherein the configuration indicates that the UE is to apply the first unified TCI state to the one A-CSI-RS resource set based at least in part on a control resource set (CORESET) pool index value of the UE being zero and apply the second unified TCI state to the one A-CSI-RS resource set based at least in part on the CORESET pool index value of the UE being one.

16. The UE of claim 13, wherein the at least one A-CSI-RS resource set includes only one A-CSI-RS resource set, and wherein the configuration indicates that the UE is to apply the first unified TCI state to the one A-CSI-RS resource set or apply the second unified TCI state to the one A-CSI-RS resource set based at least in part on a control resource set (CORESET) pool index value that corresponds to a CORESET in which the DCI is received.

17. A network entity for wireless communication, comprising:
a memory; and
one or more processors, coupled to the memory, configured to:
transmit a configuration for at least one aperiodic channel state information (CSI) reference signal (A-CSI-RS) resource set;
transmit an indication of a first unified transmission configuration indicator (TCI) state and a second unified TCI state;
transmit downlink control information (DCI) that triggers an A-CSI state that is associated with the at least one A-CSI-RS resource set;
apply at least one of the first unified TCI state or the second unified TCI state to the at least one A-CSI-RS resource set; and
transmit one or more A-CSI-RSs using one or more applied unified TCI states.

18-24. (canceled)

25. A user equipment (UE) for wireless communication, comprising:
a memory; and
one or more processors, coupled to the memory, configured to:
receive a radio resource control (RRC) message that configures the UE for receiving a two-bit transmission configuration indicator (TCI) state selection field;
receive downlink control information (DCI) that includes a codepoint in the two-bit TCI state selection field;
apply a unified TCI state, which corresponds to the codepoint, to physical downlink shared channel (PDSCH) demodulation reference signal (DMRS) ports for PDSCH occasions scheduled or activated by the DCI; and
receive a PDSCH communication using the unified TCI state.

26. The UE of claim 25, wherein the UE is configured for a time division multiplexing scheme, a spatial division multiplexing scheme, or a frequency division multiplexing scheme, and wherein the one or more processors, to apply the unified TCI state, are configured to:
apply a first unified TCI state to the PDSCH DMRS ports based at least in part on the codepoint being a first codepoint value,
apply a second unified TCI state to the PDSCH DMRS ports based at least in part on the codepoint being a second codepoint value,
apply the first unified TCI state and the second unified TCI state to PDSCH occasions, code division multiplexing (CDM) groups, or non-overlapping frequency domain resource allocations in a first order, based at least in part on the codepoint being a third codepoint value, or
apply the first unified TCI state and the second unified TCI state to PDSCH occasions, code division multiplexing (CDM) groups, or non-overlapping frequency domain resource allocations in a second order that is a reverse of the first order, based at least in part on the codepoint being a fourth codepoint value.

27. The UE of claim 25, wherein the UE is configured for a single-frequency network scheme or a coherent joint transmission scheme, and wherein the one or more processors, to apply the unified TCI state, are configured to:
apply a first unified TCI state to the PDSCH DMRS ports based at least in part on the codepoint being a first codepoint value,
apply a second unified TCI state to the PDSCH DMRS ports based at least in part on the codepoint being a second codepoint value, or
apply the first unified TCI state and the second unified TCI state to the PDSCH DMRS ports based at least in part on the codepoint being a third codepoint value.

28-30. (canceled)
